(19) United States
(12) Patent Application Publication
(10) Pub. No.: US 2022/0303268 A1
(43) Pub. Date: Sep. 22, 2022

(54) PASSWORDLESS LOGIN

(71) Applicant: Citrix Systems, Inc., Ft. Lauderdale, FL (US)

(72) Inventors: Sotirios Marios Karnaros, Patras (GR); Chris Pavlou, Boca Raton, FL (US); Daniel G. Wing, Truckee, CA (US)

(73) Assignee: Citrix Systems, Inc., Ft. Lauderdale, FL (US)

(21) Appl. No.: 17/232,550

(22) Filed: Apr. 16, 2021

Related U.S. Application Data
(63) Continuation of application No. PCT/GR2021/000016, filed on Mar. 19, 2021.

(51) Int. Cl. H04L 29/06; H04L 9/30; H04L 9/32; H04L 9/08; G06F 21/60; G06K 7/14; G06K 7/10

(52) U.S. Cl. CPC H04L 63/0853; H04L 9/30; H04L 9/3271; H04L 63/0861; H04L 63/123; H04L 9/0897; H04L 9/3247; G06F 21/602; G06K 7/1417; G06K 7/10722

(57) ABSTRACT

A computer system is provided. The computer system includes a memory, a network interface, and at least one processor coupled to the memory and the network interface. The at least one processor is configured to receive, via the network interface, a signed response to a challenge, verify the signed response using a public key associated with a mobile computing device, and log a user account associated with the public key into an application in response to verification of the signed response, thereby allowing access to the application.

### RELATED APPLICATIONS

This application claims priority under 35 U.S.C. § 120 as a continuation of PCT Application No. PCT/GR2021/000016, titled “PASSWORDLESS LOGIN,” filed Mar. 19, 2021. PCT Application No. PCT/GR2021/000016 is hereby incorporated herein by reference in its entirety.

### BACKGROUND

Systems execute login processes to authenticate users and to grant users access to system resources. One authentication mechanism that is widely used within login processes is the user password. User passwords benefit from their ability to be easily recognized by computer systems through standard input devices and without the need for sensors or other specialized hardware. Once authenticated via a user password, an associated user identifier provides an excellent basis for the granting of rights to particular user data, software applications, and data storage using any of a variety of authorization systems designed for rights management.

### SUMMARY

In at least one example, a computer system is provided. The computer system includes a memory, a network interface, and at least one processor coupled to the memory and the network interface. The at least one processor is configured to receive, via the network interface, a signed response to a challenge, verify the signed response using a public key associated with a mobile computing device, and log a user account associated with the public key into an application in response to verification of the signed response, thereby allowing access to the application.

In the computer system, the at least one processor can be further configured to identify an association between the application and a client computer system hosting the application. The application can include either a browser or an operating system. The application can include a digital workspace client.

Some examples of the computer system include one or more of the following features. The computer system can further include the mobile computing device. The mobile computing device can include a security chip and can be configured to receive the challenge, sign the challenge with a private key using the security chip to generate the signed response, and transmit the signed response to the at least one processor. The mobile computing device can further include at least one biometric sensor. The mobile device can be configured to biometrically authenticate a user prior to signature of the challenge.

In the computer system, the at least one processor can be further configured to transmit, to the application via the network interface, an identifier of an application programming interface (API) endpoint implemented by the at least one processor and to receive the signed response comprises to receive the signed response via the API endpoint.

The computer system can further include a client computer configured to execute the application, receive the identifier of the API endpoint, and communicate the identifier of the API endpoint to the mobile computing device. In the computer system, to communicate the identifier can include either to render a QR code encoding the identifier of the API endpoint or to transmit a wave modulated to encode the identifier of the API endpoint.

The computer system can further include the mobile computing device. The mobile computing device can further include a camera. In the computer system, to communicate the identifier can include to render a QR code encoding the identifier of the API endpoint. In the computer system, the mobile device can be configured to scan the QR code with the camera to receive the identifier of the API endpoint and transmit the signed response to the API endpoint.

In another example, a method of logging into a computer system without a password is provided. The method includes receiving a signed response to the challenge, verifying the signed response using a public key associated with the mobile computing device, and logging a user account associated with the public key into an application comprising a browser in response to verification of the signed response, thereby allowing access to the application.

Some examples of the method include one or more of the following features. In the method, logging the user account into the application can include logging the user account into a digital workspace client. The method can further include receiving, by the mobile computing device, the challenge, signing the challenge with a private key using a security chip to generate the signed response, and transmitting the signed response to at least one processor of the computer system. The method can further include biometrically authenticating a user prior to signature of the challenge. The method can further include transmitting, to the application, an identifier of an application programming interface (API) endpoint, wherein receiving the signed response comprises receiving the signed response via the API endpoint. The method can further include hosting, by a client computer, the application; receiving the identifier of the API endpoint; and communicating the identifier of the API endpoint to the mobile computing device. In the method, communicating the identifier can include either rendering a QR code encoding the identifier of the API endpoint or transmitting a wave modulated to encode the identifier of the API endpoint. In the method, communicating the identifier can include rendering a QR code encoding the identifier of the API endpoint. The method can further include scanning the QR code with a camera of the mobile computing device to receive the identifier of the API endpoint and transmitting, by the mobile computing device, the signed response to the API endpoint.

In another example, a non-transitory computer readable medium is provided. The medium stores processor executable instructions to log into a computer system without a password. The instructions include instructions to receive a signed response to a challenge, verify the signed response using a public key associated with a mobile computing device, and log a user account associated with the public key into an application comprising a browser in response to verification of the signed response, thereby allowing access to the application.

Some examples of the medium include one or more of the following features. On the medium, the instructions to log the user account into the application can include instructions to log the user account into a digital workspace client. The instructions can further comprise instructions to transmit, to the application, an identifier of an application programming interface (API) endpoint, wherein to receive the signed response comprises to receive the signed response via the API endpoint.

In another example, a mobile computing device is provided. The mobile computing device includes a memory, a network interface, and at least one processor coupled to the memory, and the network interface. The at least one processor is configured to transmit, via the network interface, a login request to a computer system; receive, via the network interface, a challenge in response to the login request; initiate signature of the challenge to generate a signed response; and transmit, via the network interface, the signed response to the computer system.

Some examples of the mobile computing device include one or more of the following features. The mobile computing device can further include a secure local storage configured to store a private key and a security chip configured to sign the challenge using the private key. The mobile computing device can further include a sensor coupled to the at least one processor, wherein the at least one processor is further configured to authenticate an owner of the private key prior to initiation of the signature. The sensor can include a biometric sensor. This owner can be a user of the mobile computing device or the mobile computing device itself.

Still other aspects, examples and advantages of these aspects and examples, are discussed in detail below. Moreover, it is to be understood that both the foregoing information and the following detailed description are merely illustrative examples of various aspects and features and are intended to provide an overview or framework for understanding the nature and character of the claimed aspects and examples. Any example or feature disclosed herein can be combined with any other example or feature. References to different examples are not necessarily mutually exclusive and are intended to indicate that a particular feature, structure, or characteristic described in connection with the example can be included in at least one example. Thus, terms like “other” and “another” when referring to the examples described herein are not intended to communicate any sort of exclusivity or grouping of features but rather are included to promote readability.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 is a block diagram illustrating a passwordless login process in accordance with an example of the present disclosure.

FIG. 2 is a block diagram a illustrating a registration process in accordance with an example of the present disclosure.

FIG. 3 is a block diagram depicting a passwordless login system in accordance with an example of the present disclosure.

FIGS. 4A and 4B are a flow diagram showing a passwordless login process in accordance with an example of the present disclosure.

FIGS. 5A-5C are a flow diagram illustrating a registration process in accordance with an example of the present disclosure.

FIG. 6A is a flow diagram showing another registration process in accordance with an example of the present disclosure.

FIGS. 6B-6D are a flow diagram showing another registration process in accordance with an example of the present disclosure.

FIGS. 7A-7C are a flow diagram depicting a passwordless login process in accordance with an example of the present disclosure.

FIGS. 8A-8D are a flow diagram illustrating another passwordless login process in accordance with an example of the present disclosure.

FIG. 9A and 9B are a flow diagram showing another registration process in accordance with an example of the present disclosure.

FIG. 10 is a block diagram of a network environment of computing devices in which various aspects of the present disclosure can be implemented.

### DETAILED DESCRIPTION

As summarized above, at least some examples described herein are directed to systems and methods that enable users to securely log into a system without using a password. These passwordless login systems and methods overcome several disadvantages of other login systems. For instance, the systems and methods described herein can utilize local hardware (e.g., biometric sensors, security chips, and the like) to authenticate a user. This local hardware can be part of a mobile computing device (e.g., a smartphone, tablet, laptop, or the like) already possessed and utilized by the user for a variety of purposes, thereby alleviating any need for dedicated hardware. Moreover, by utilizing hardware-based authentication, the systems and methods described herein authenticate users more securely and conveniently than is possible via the use of passwords.

In fact, the use of passwords as an authentication mechanism is a global security problem. Passwords are not secure as they can be easily passed from person to person, are less convenient for users because they must be remembered, and present privacy concerns. Moreover, at the enterprise level, an effective password policy is not scalable. More specifically, regarding security, passwords at endpoint devices are subject to phishing attacks. Further, passwords at the host are susceptible to stealing attacks, even where the passwords are hashed, and regardless of whether they are stored in dedicated or cloud-based storage. Regarding convenience, remembering passwords for different accounts becomes challenging to a user as the number of the user's accounts increase. To alleviate this challenge, the user may choose to save their passwords securely in the credential manager of an endpoint device. However, if the endpoint device fails to retrieve the saved passwords securely, the user is required to perform additional actions to identify herself and to create a new password. Moreover, passwords are recommended to be changed at regular intervals. All of the above contribute to the inconvenience endured by users of password-based login systems.

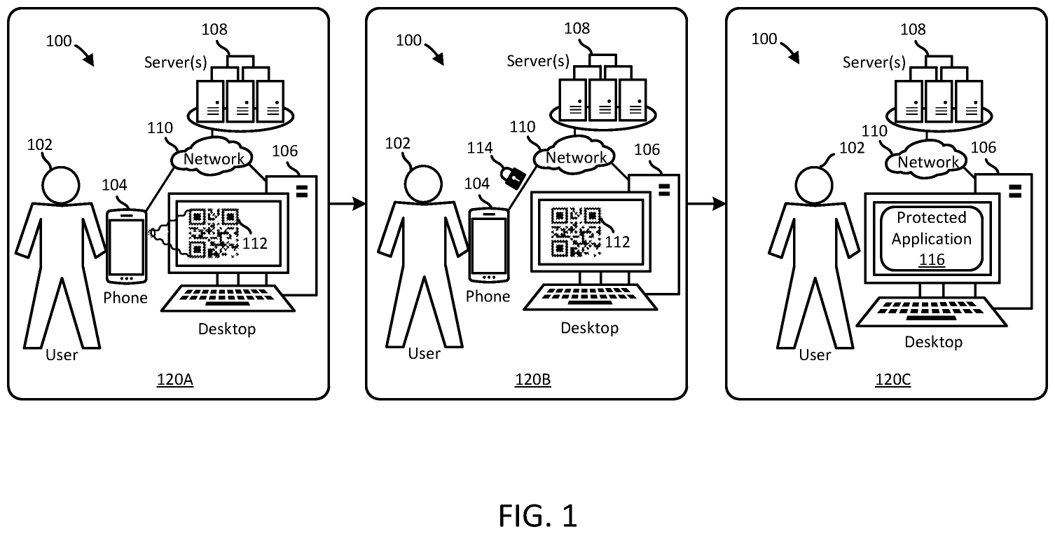

To address the disadvantages described above, as well as other issues, passwordless login systems and processes are provided. These systems and processes enable a user to log securely and conveniently into a system using a registered mobile computing device, such as a smartphone or tablet. After successful authentication, passwordless login systems and processes provide the user with access to system resources that the user is authorized to access. FIG. 1 illustrates, by way of introduction, a three stage login process enabled by the passwordless login systems and processes described herein.

As shown in FIG. 1, the passwordless login system 100 includes a smartphone 104, a desktop computer 106, one or more server(s) 108, and a network 110. The smartphone 104, desktop 106, and the server(s) 108 communicate with one another via the network 110. The smartphone 104 and the desktop 106 are registered with the server(s) 108 using a registration process that is described further below. As one effect of this registration, the server(s) 108 serves a quick reference (QR) code 112 to an application 116 hosted by the desktop 106 and protected by security incorporated into the system 100. This QR code 112 encodes information used by the smartphone 104 to log the user 102 into the system 100, as described below.

In stage 120A, the user 102 approaches the desktop 106 with the intention of accessing the protected application 116. The protected application 116 may be a browser, an operating system logon control (e.g. a MICROSOFT WINDOWS system logon), a digital workspace application, (e.g., the Citrix Workspace™ application commercially available from Citrix Systems, Inc. of Fort Lauderdale, Florida, in the United States) or the like. The user 102 manipulates the smartphone 104 to scan the QR code 112.

In response to reception and decoding of the QR code 112, the smartphone 104 communicates with the server(s) 108 via the network 110 and receives an identifier of a computing session from the server(s) 108. The smartphone 104 prompts the user 102 to select a user account (where multiple, registered user accounts exist for the smartphone 104) and to authenticate (e.g., biometrically via an embedded biometric sensor, such as a fingerprint scanner). Responsive to successful authentication, the smartphone 104 signs the identifier of the computing session with a locally and securely stored private key. This private key may have been generated using any of several asymmetric key processes (e.g., a Digital Signature Standard process, an Elliptic Curve Digital Signature process, a Rivest-Shamir-Adleman process, or the like.)

The private key can be securely stored in a data store that is isolated and dedicated, at the hardware level, to a security chip configured to provide cryptographic services to the smartphone 104.

In stage 120B, the smartphone 104 transmits the signed login session identifier 114 to the server(s) 108 via the network 110. Responsive to reception of the signed identifier 114, the server(s) 108 verify the signed identifier 114 using a public key corresponding to the private key. This public key can be associated, within the memory of the server(s) 108, with the smartphone 104. This verification authenticates the user 102 to the overall system generally and to the protected application 116 specifically.

In stage 120C, the server(s) 108 interoperates with the desktop 106 to unlock and log the user into the protected application 116, thereby making it available for use by the user 102 with permissions associated with the selected user account.

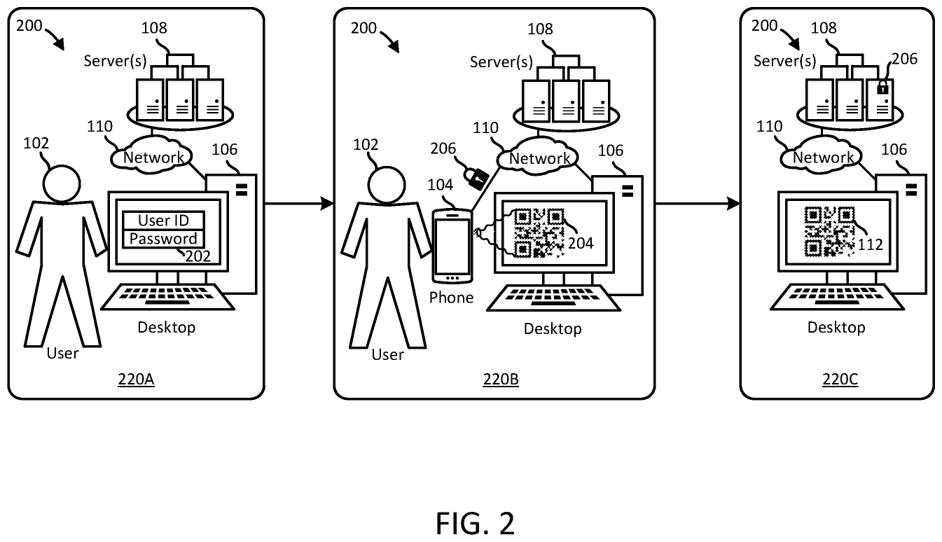

As explained above, to enable the user 102 to authenticate securely and conveniently to a system using a mobile computing device, the mobile computing device must be registered. FIG. 2 illustrates, by way of introduction, a three stage registration process enabled by the passwordless login systems and processes described herein.

As shown in FIG. 2, the passwordless login system 200 includes the smartphone 104, the desktop computer 106, the one or more server(s) 108, and the network 110 illustrated in FIG. 1. However, in stage 220A of FIG. 2, the smartphone 104 is has not yet been registered for passwordless login by the system 200. As illustrated in stage 220A, the user 102 approaches the desktop 106 with the intention of registering the smartphone 104 for passwordless login to the system 200. The desktop 106 renders a user interface 202 that prompts the user 102 to enter security credentials (e.g., an identifier of the user's account and a password). The user interface 202 may be a native application hosted by the desktop 106 or be served via a browser executing on the desktop 106 by the server(s) 108 via the network 110. In response to reception of the security credentials, the desktop 106 communicates with the server(s) 108 to authenticate the security credentials. In response to successful authentication of the security credentials, the server(s) 108 initiates a session to register the smartphone 104, encodes a token associated with the registration session into a QR code 204, and communicates the QR code 204 to the desktop 106.

In stage 220B, the desktop 106 displays the QR code 204. The user 102 manipulates the smartphone 104 to scan the QR code 204. In response to reception and decoding of the QR code 204, the smartphone 104 authenticates (e.g., biometrically) the user 102 and securely generates (e.g., via a security chip embedded within the smartphone 104) a public/private key pair that includes a public key 206. The smartphone 104 communicates an identifier of the smartphone 104 and the public key 206 to the server(s) 108.

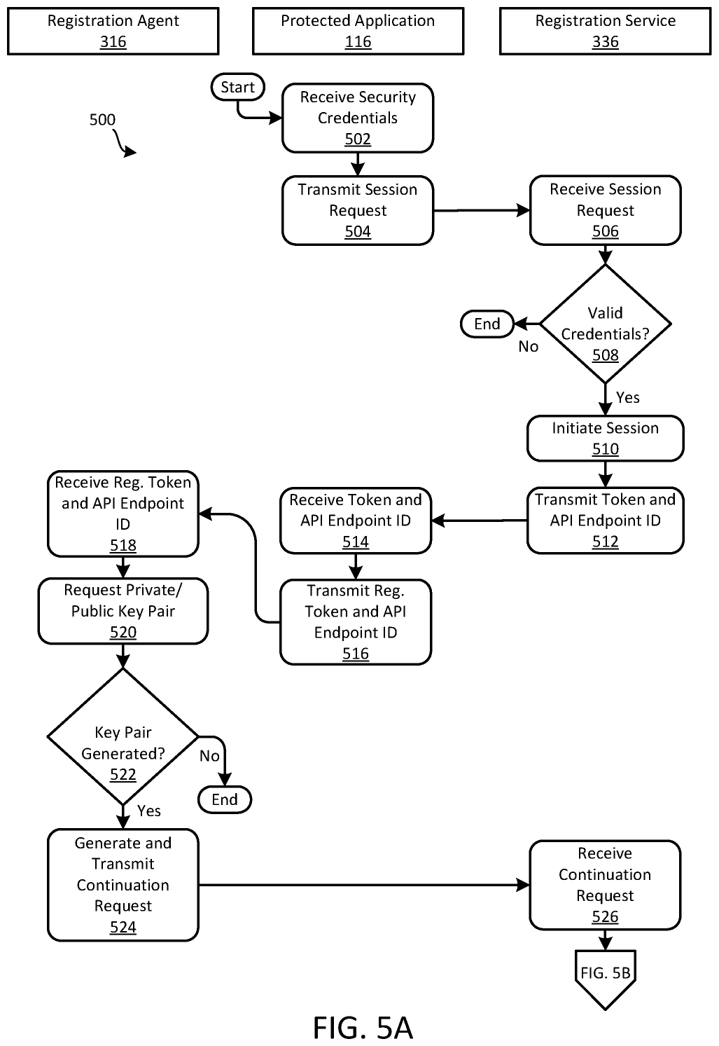

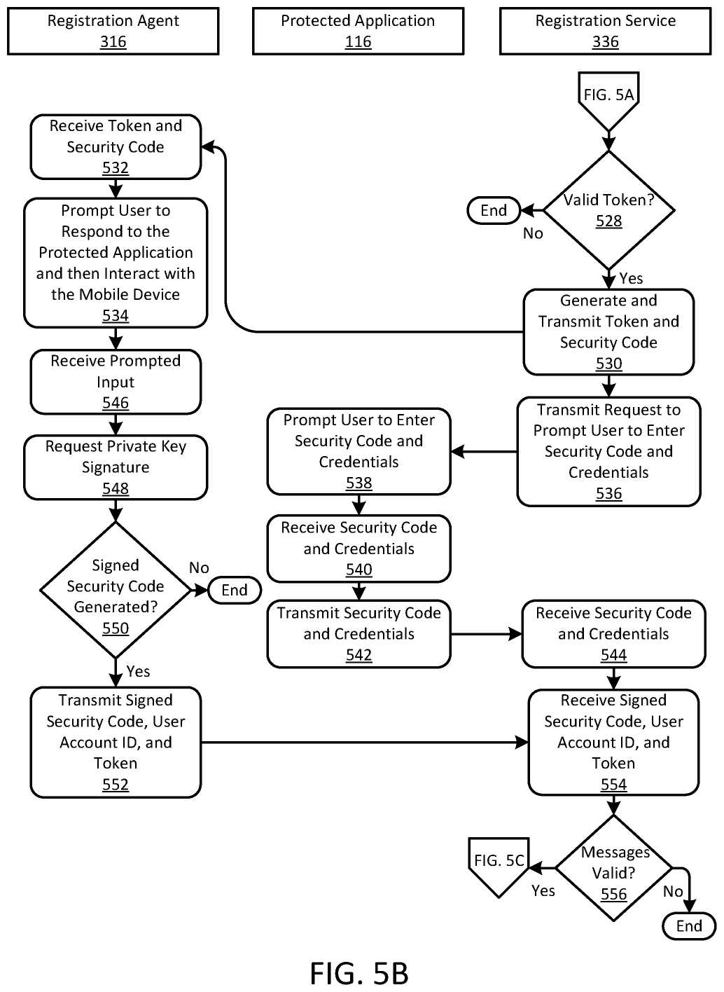

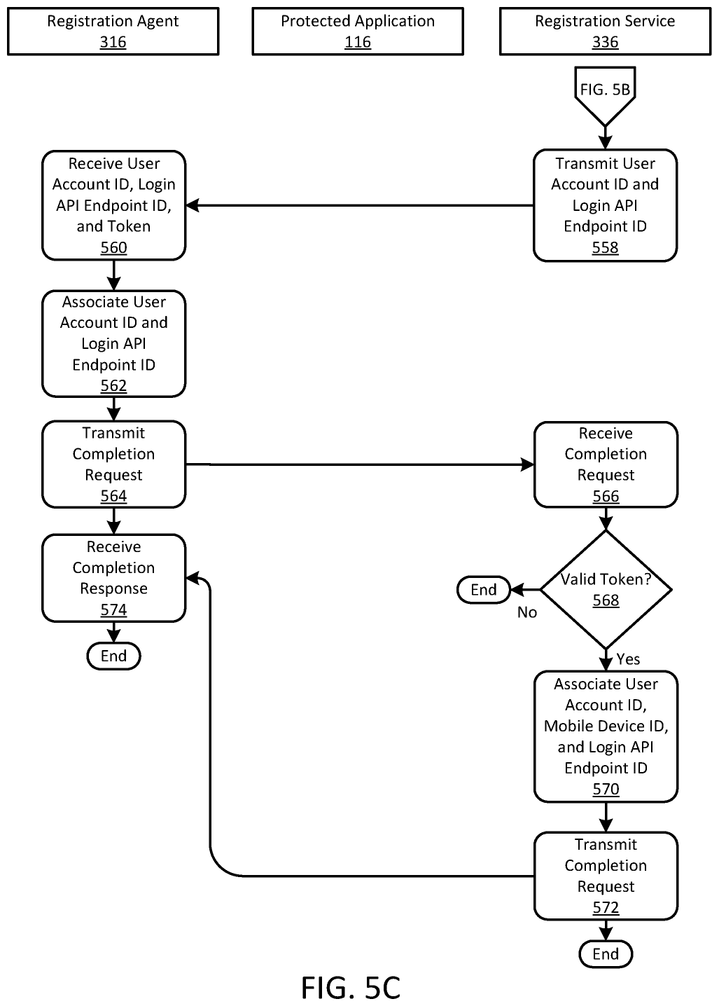

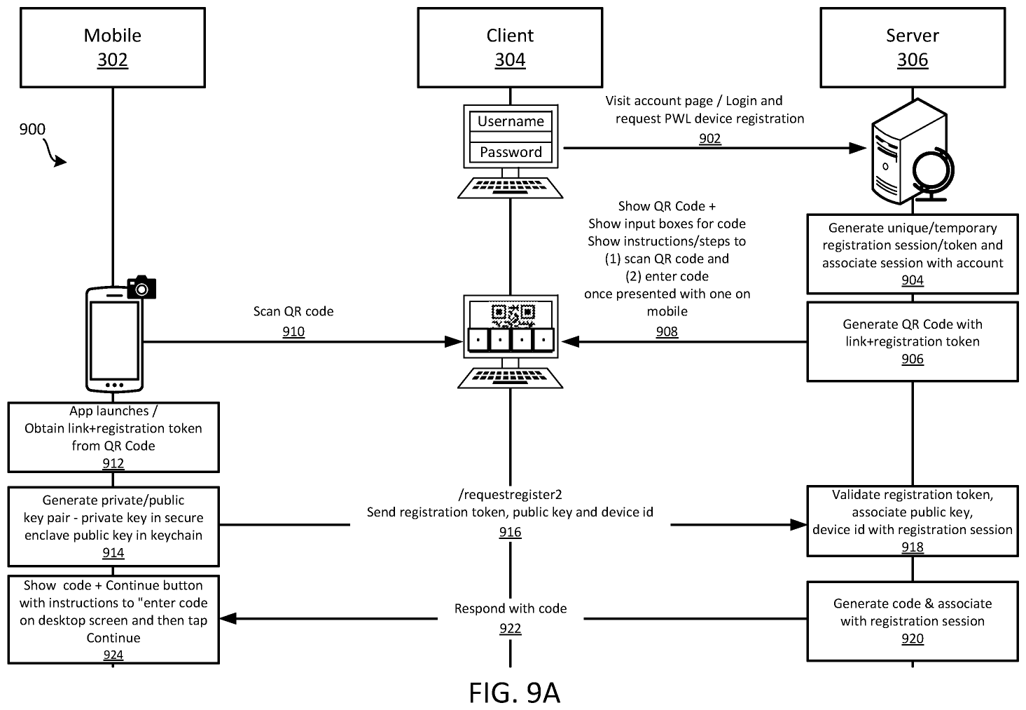

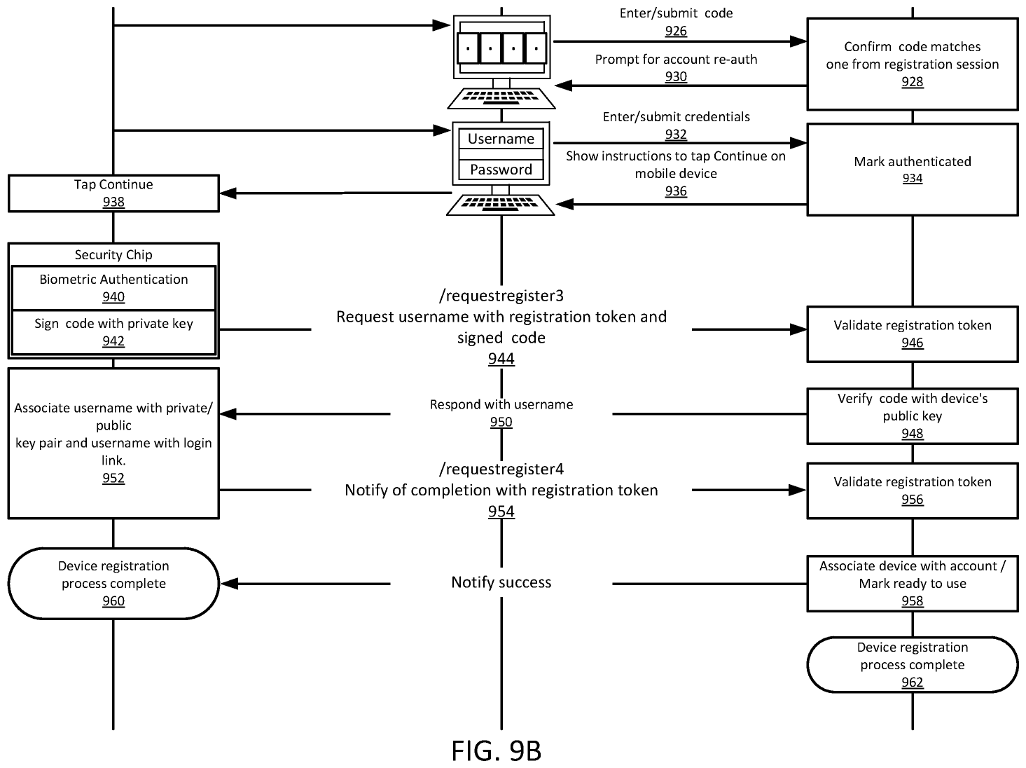

In stage 220C, the server(s) 108 receive the public key 206 and store the public key in association with the identifier of the smartphone 104 for subsequent use in the login process described above with reference to FIG. 1. It should be noted that, in some examples, the registration process of FIG. 2 includes additional authentication operations to provide additional security to the registration process. These additional authentication operations can involve a security code generated by the server(s) 108, signed by the smartphone 104, or entered by the user into the desktop 106. Examples of the additional authentication operations and the security code are described below, with reference to FIGS. 5A-5C, 9A, and 9B.

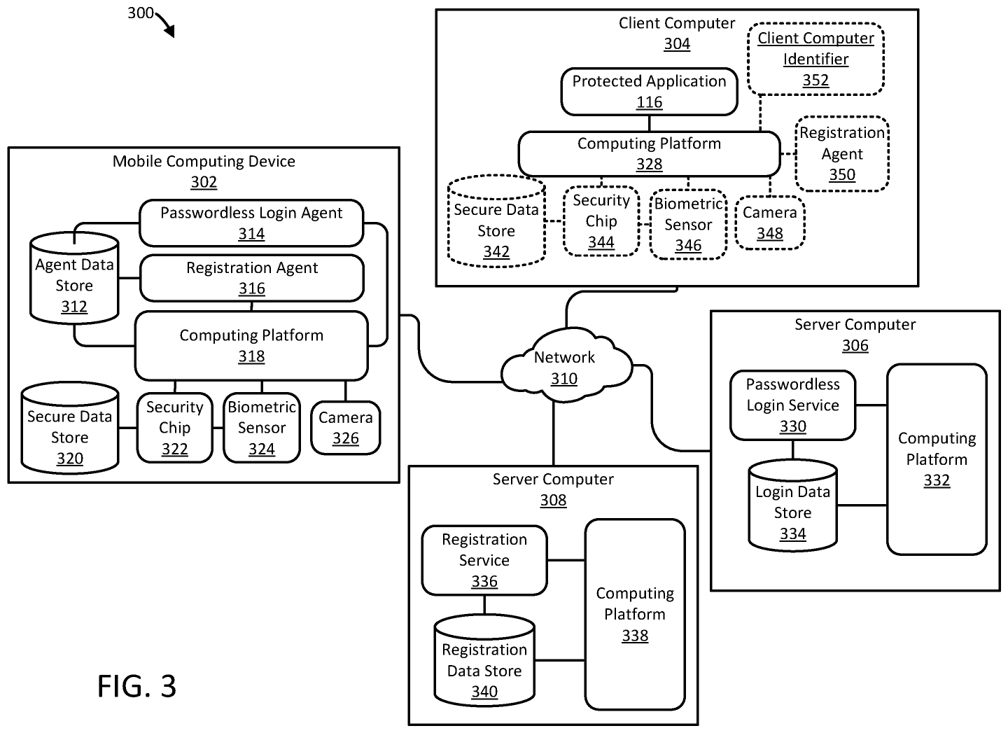

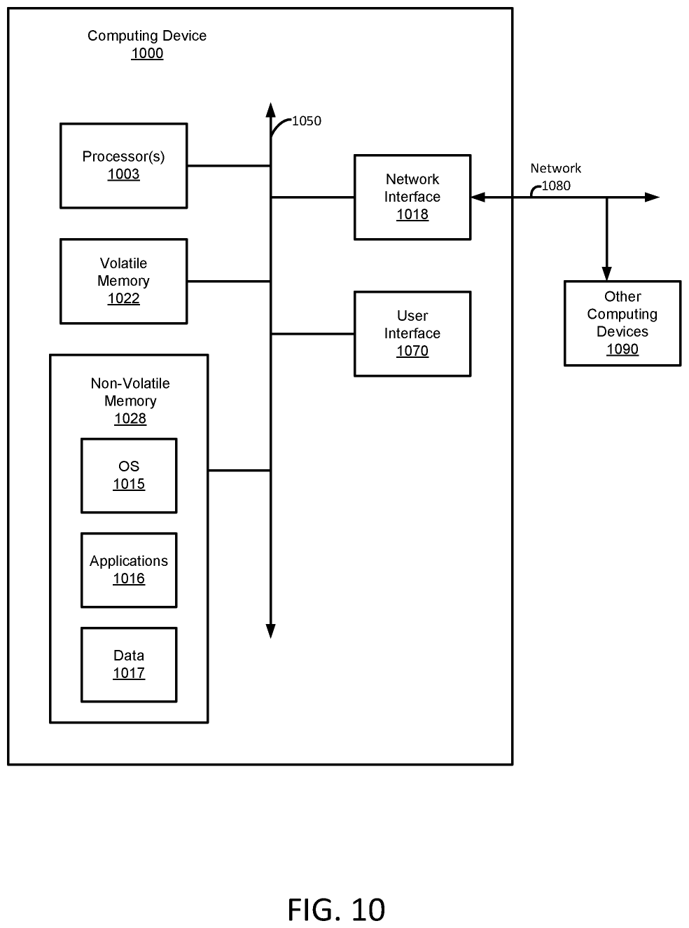

FIG. 3 illustrates a logical and physical architecture of a passwordless login system 300. As shown in FIG. 3, the system 300 includes a mobile computing device 302, a client computer 304, and server computers 306 and 308 that are configured to interoperate with one another via a network 310. The mobile device 302 includes an agent data store 312, a passwordless login agent 314, a registration agent 316, a computing platform 318, a secure data store 320, a security chip 322, a sensor (e.g., biometric sensor) 324, and a camera 326. The client computer 304 includes the protected application 116 of FIG. 1 and a computing platform 328. Additionally, some examples of the client computer 304 further include secure data store 342, security chip 344, sensor (e.g. biometric sensor) 346, camera 348, a registration agent 350, and a client computer identifier 352. The server computer 306 includes a passwordless login service 330, a computing platform 332, and a login data store 334. The server computer 308 includes a registration service 336, a computing platform 338, and a registration data store 340. Each of the computing platforms 318, 328, 332, and 338 includes at least one processor coupled to memory and an network interface via an interconnection mechanism, such as a bus. Each of these processors and memory are configured to execute an operating system. Examples of the structures and processes that constitute the computing platforms 318, 328, 332, and 338 are described further below with reference to FIG. 10.

As shown in FIG. 3, the mobile device 302 and some examples of the client computer 304 include several specialized components, in addition to the computing platforms 318 and 328, that support execution of the passwordless login and registration processes described herein. For instance, the sensors 324 and 346 enable the mobile device 302 and some examples of the client computer 304 to acquire biometric data that uniquely identifies a user. Examples of the sensors 324 and 346 include a fingerprint scanner, a retinal scanner, and a voice scanner to name a few. Via the sensors 324 and 346, the mobile device 302 and some examples of the client computer 304 can acquire, derive, and store sensor data that can be used to later identify individual users of the mobile device 302 and some examples of the client computer 304.

Other components of the mobile device 302 and some examples of the client computer 304 enable local, secure, and encapsulated cryptography. For instance, the security chips 322 and 344 and the secure data stores 320 and 342 enable the mobile device 302 and some examples of the client computer 304 to create and store cryptographic keys (e.g., symmetric and asymmetric) in association with sensor data that identifies owners of the keys. This capability ensures that cryptographic operations (e.g., encryption, key signing, etc.) that rely on a particular key can be successfully executed only by a biometrically authenticated owner of the key. Examples of the security chip 344 include the T2 security chip commercially available in products from Apple Inc. of Cupertino, Calif. in the United States and the INTEL SGX platform commercially available from Intel Corporation of Santa Clara, California in the United States. Examples of the security chip 322 include the Titan M security chip commercially available in products from Google Inc. of Mountain View, Calif. in the United States and the Secure Enclave Process incorporated into the A-series processor from Apple Inc. It should be noted that, in some examples, messages with cryptographic content exchanged between the mobile device 302 and some examples of the server computers 306 and 308 may conform with OAuth 2.0 Authorization Framework and OAuth 2.0 Device Authorization Grant as defined in Internet Engineering Task Force Request for Comments 6749 and 8628. It should be appreciated that, some examples of the security chip 322 incorporate and isolate the secure data store 320.

Other components of the mobile device 302 and some examples of the client computer 304 support acquisition of signals communicating information from other devices. For instance, the cameras 326 and 348 enable the mobile device 302 and some examples of the client computer 304 to acquire images of fiducials, such as QR codes, that visually encode data. Similarly, the computing platforms 318 and 328 can include wireless network interfaces (e.g., comprising antennas, light emitters, cameras, etc.) that can transmit and receive waves, such as BLUETOOTH, WI-FI, or Li-Fi signals, that are modulated to communicate data. Via the cameras 326 and 348 and the computing platforms 318 and 328, the mobile device 302 and some examples of the client computer 304 can acquire, derive, and store data communicated by, for example, the network 310 and other devices within the vicinity of the mobile device 302 and some examples of the client computer 304.

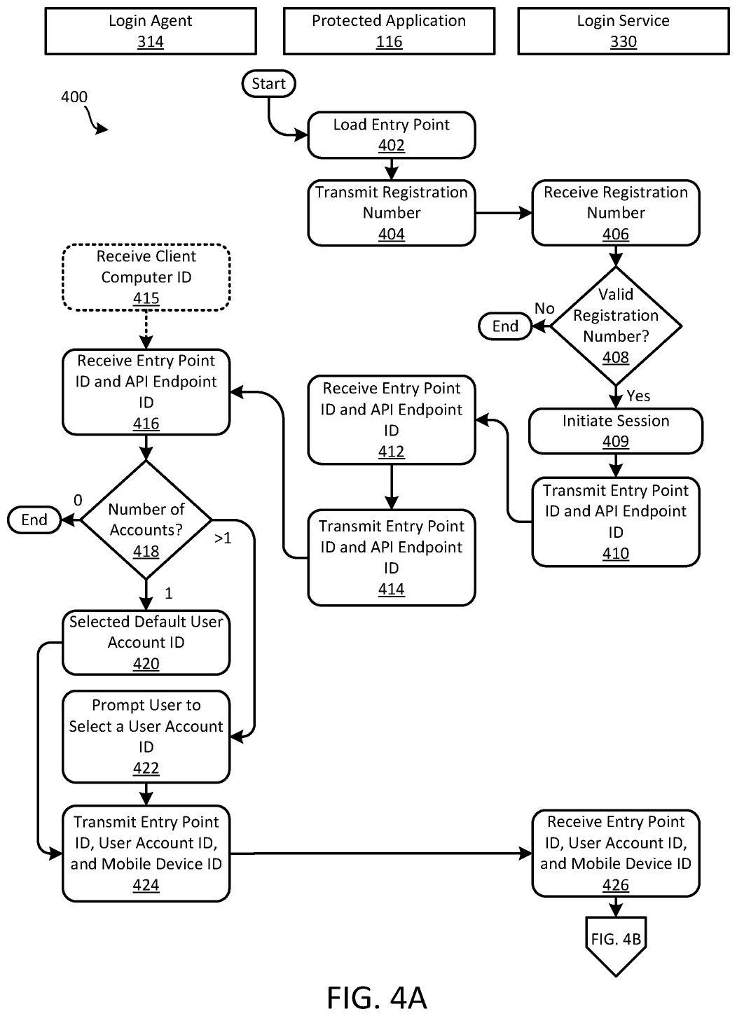

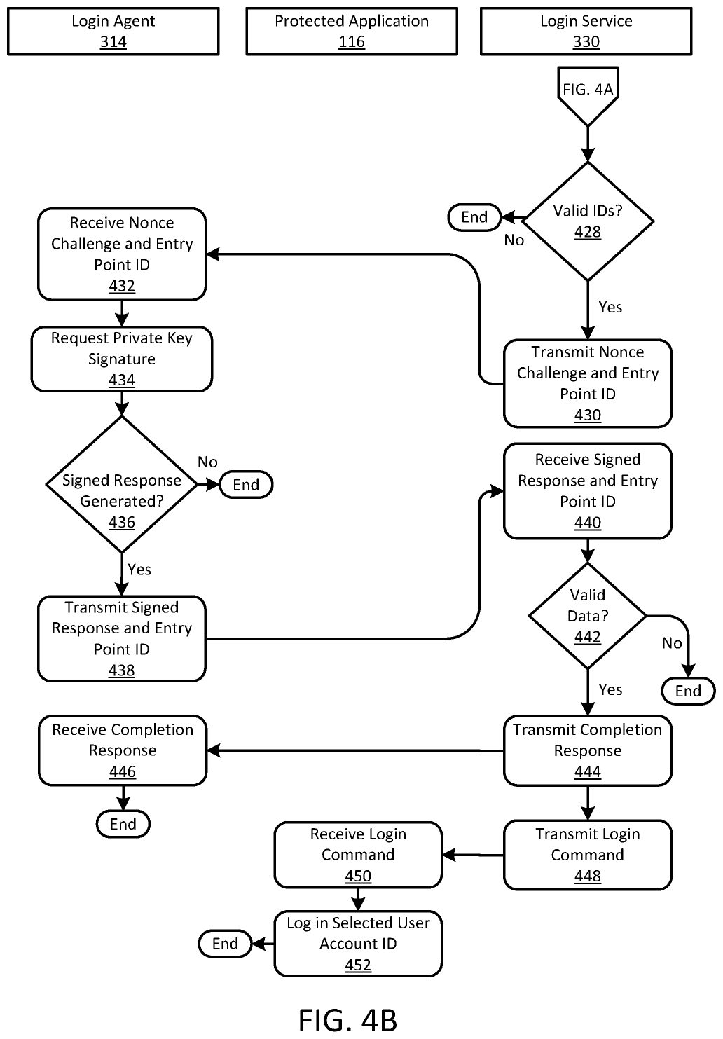

As shown in FIG. 3, the login agent 314 is configured to control components of the mobile device 302, such as those described above, during execution of passwordless login processes. These processes involve a variety of operations internal to the mobile device 302 and interoperations between the login agent 314, the protected application 116, the login service 330, and the registration service 336. Examples of operations that the login agent 314 is configured to execute within passwordless login processes are described further below with reference to FIGS. 4A, 4B, and 7A-8D.

Continuing with the system 300, the registration agent 316 is configured to control components of the mobile device 302 during execution of registration processes. These processes involve a variety of operations internal to the mobile device 302 and interoperations between the registration agent 316, the protected application 116, and the registration service 336. Examples of operations that the registration agent 316 is configured to execute within registration processes are described further below with reference to FIGS. 5A-5C, 9A, and 9B.

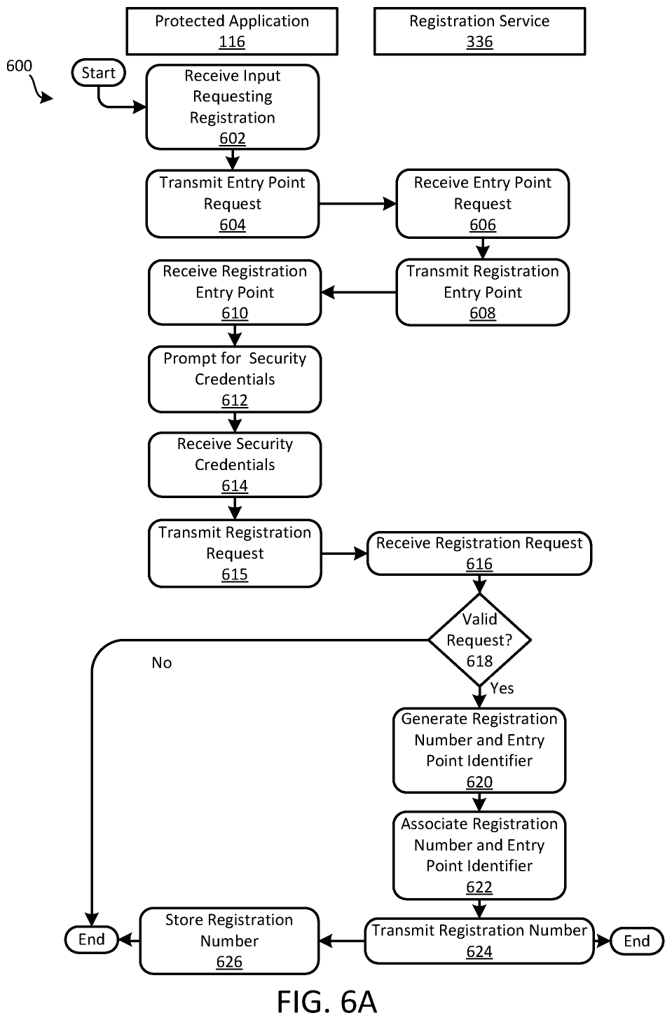

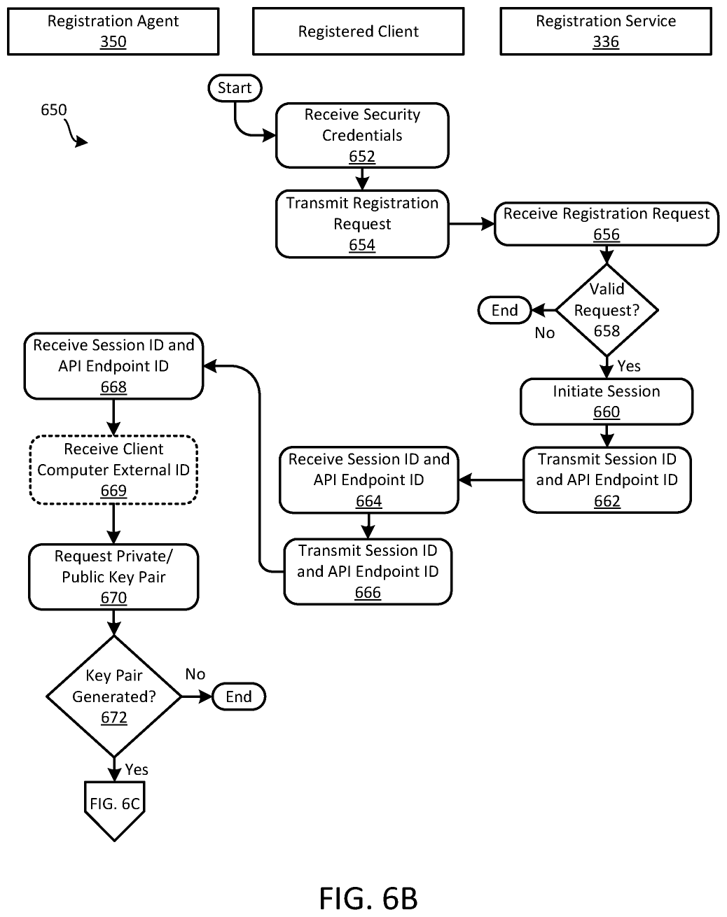

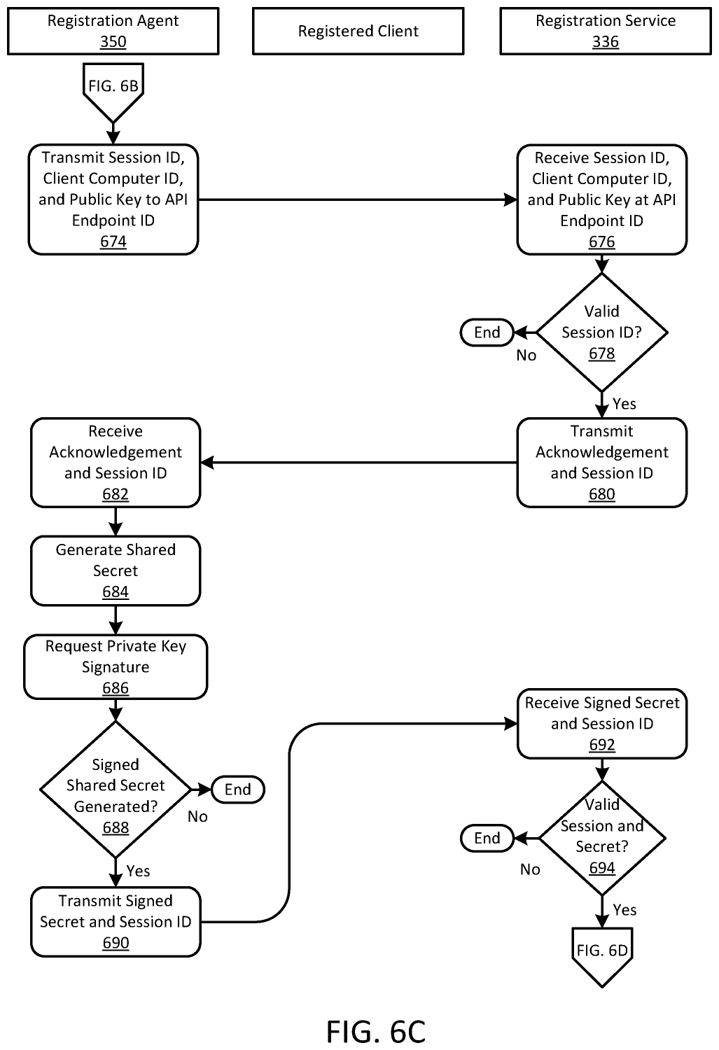

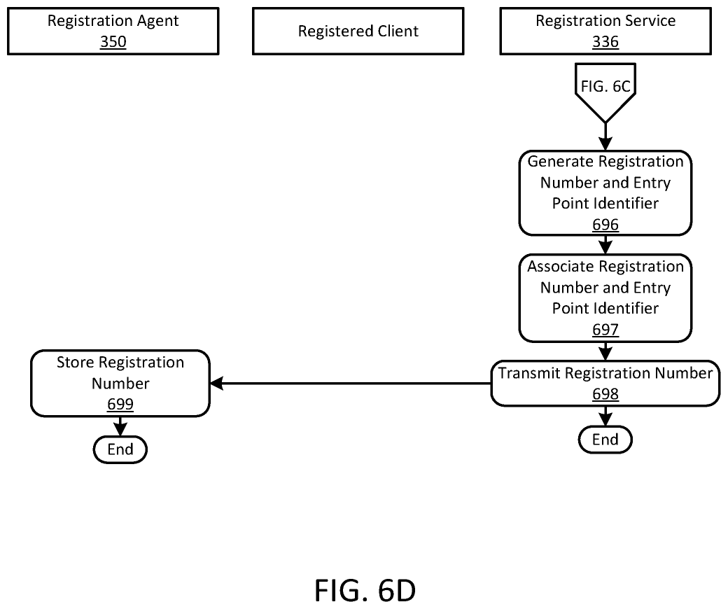

Continuing with the system 300, the registration agent 350 of the client computer is configured to control components of that device during execution of some registration processes. These processes involve a variety of operations internal to the client computer 304 and interoperations between the registration agent 350, a registered client application hosted by a computer system like the client computer 304, and the registration service 336. Examples of operations that the registration agent 350 is configured to execute within registration processes are described further below with reference to FIGS. 6A and 6B.

Continuing with the system 300, the protected application 116 of the client computer 304 can be a browser, a digital workspace application, an operating system logon prompt (e.g., a Windows Credential Provider), or the like. In certain examples, a digital workspace application is a software program configured to deliver and manage a user's applications, data, and desktops in a consistent and secure manner, regardless of the user's device or location. The workspace application enhances the user experience by streamlining and automating those tasks that a user performs frequently, such as approving expense reports, confirming calendar appointments, submitting helpdesk tickets, and reviewing vacation requests. The workspace application allows users to access functionality provided by multiple enterprise applications—including “software as a service” (SaaS) applications, web applications, desktop applications, and proprietary applications—through a single interface. In some examples, the workspace application includes an embedded browser. The embedded browser can be implemented, for example, using the Chromium Embedded Framework.

In some examples, the protected application 116 participates in a virtual computing session with a remote server computer via a virtualization infrastructure. This virtualization infrastructure enables an application or OS executing within a first physical computing environment (e.g., the server computer) to be accessed by a user of a second physical computing environment (e.g., an endpoint device, such as the client computer 304) as if the application or OS was executing within the second physical computing environment. Within the virtualization infrastructure, a server virtualization agent resident on the server computer is configured to make a computing environment in which it operates available to execute virtual (or remote) computing sessions. This server virtualization agent can be further configured to manage connections between these virtual computing sessions and other processes within the virtualization infrastructure, such as a client virtualization agent resident on the client computer 304. In a complementary fashion, the client virtualization agent is configured to instigate and connect to the virtual computing sessions managed by the server virtualization agent. The client virtualization agent is also configured to interoperate with other processes executing within its computing environment (e.g., the protected application 116) to provide those processes with access to the virtual computing sessions and the virtual resources therein. Within the context of a Citrix HDX™ virtualization infrastructure, the server virtualization agent can be implemented as, for example, a virtual delivery agent installed on a physical or virtual server or desktop and the client virtualization agent can be implemented as a service local to the client computer 304.

In some examples, the protected application 116 is configured to control components of the client computer 304 during execution of some registration processes. These processes involve a variety of operations internal to the client computer 304 and interoperations between the protected application 116 and the registration service 336. Examples of operations that the protected application 116 is configured to execute within some registration processes are described further below with reference to FIG. 6A.

Continuing with the system 300, the login service 330 is configured to control components of the server computer 306, such as those described above, during execution of passwordless login and registration processes. These processes involve a variety of operations internal to the server computer 306 and interoperations between the login agent 314, the protected application 116, the login service 330, and the registration service 336. Examples of operations that the login service 330 is configured to execute within passwordless login and registration processes are described further below with reference to FIGS. 4A, 4B, and 7A-8D.

Continuing with the system 300, the registration service 336 is configured to control components of the server computer 308, such as those described above, during execution of passwordless login and registration processes. These processes involve a variety of operations internal to the server computer 308 and interoperations between the registration agent 316, the registration agent 350, the protected application 116, and the registration service 336. Examples of operations that the registration service 336 is configured to execute within passwordless login and registration processes are described further below with reference to FIGS. 5A-6C, 9A, and 9B.

Each of the data stores 312, 320, 334, 340, and 342 can be organized according to a variety of physical and logical structures. For instance, as will be described in greater detail below, some of the data stores 312, 320, 334, 340, and 342 include data structures that store associations between identifiers of various system elements and workpieces. Within these data structures, the identifiers can be, for example, globally unique identifiers (GUIDs). Moreover, each of the data stores 312, 320, 334, 340, and 342 can be implemented, for example, as a relational database having a highly normalized schema and accessible via a structured query language (SQL) engine, such as ORACLE or SQL-SERVER. Alternatively or additionally, one or more of the data stores 312, 320, 334, 340, and 342 can include hierarchical databases, xml files, NoSQL databases, document-oriented databases, flat files maintained by an operating system and including serialized, proprietary data structures, and the like. Moreover, some or all of the datastores 312, 320, 334, 340, and 342 can be allocated in volatile memory to increase performance. Thus, each of the data stores 312, 320, 334, 340, and 342 as described herein is not limited to a particular implementation.

It should be noted that, in certain examples, the login service 330 and the registration service 336 can be hosted by the same server computer. In some of these examples, the login service and the registration service can be differentiated by domain (e.g., login.example.com versus register.example.com) or by Hypertext Transfer Protocol path (e.g., example.com/login versus example.com/register). Alternatively or additionally, the login service 330 and the registration service 336 can be combined into a single login service, in some examples. Similarly, the login agent 314 and the registration agent 316 can be combined into a single login agent, in some examples. Also, in certain examples where the protected application 116 includes a browser, the protected application 116 can utilize transport layer security when communicating with the registration service 336 or the login service 330.

As explained above, in some examples a passwordless login system (e.g., the system 300 of FIG. 3) executes one or more passwordless login processes. FIGS. 4A and 4B illustrate a passwordless login process 400 executed by a passwordless login system in some examples. As shown in FIGS. 4A and 4B, the process 400 is executed by a login agent (e.g., the login agent 314 of FIG. 3), a protected application (e.g., the protected application 116 of FIGS. 1 and 3), and a login service (e.g., the passwordless login service 330 of FIG. 3). The login agent is hosted by a mobile device (e.g., the mobile device 302 of FIG. 3). The protected application is hosted by a client computer (e.g., the client computer 304 of FIG. 3). The login service is hosted by a server computer (e.g., the server computer 306 of FIG. 3).

With reference to FIG. 4A, the process 400 starts with the protected application loading 402 an entry point for logging into the system without a password. For instance, where the protected application includes a browser, the browser loads 402 a locally cached web page originally received from the login service during execution of a registration process of the client computer (e.g., the registration process 600 described below in FIGS. 6A). Alternatively or additionally, the browser requests the web page from the login service and loads 402 the web page responsive to its reception.

In some examples, the web page includes an embedded request (e.g., JavaScript code) for the browser to transmit a locally stored registration number for the web page to the login service. Alternatively or additionally, in some examples, the login service requests transmission of the locally stored registration number as part of serving the web page to the browser. In either case, the browser transmits 404 the registration number to the login service. The registration number is an identifier of the web page that can be store locally as, for example, a cookie created during registration of the client computer. This registration number can identify the web page and the protected application as an entry point to the system.

The login service receives 406 the registration number. For instance, in one example, the login service receives the registration cookie and extracts the registration number from the registration cookie. Next, the login service determines 408 whether the registration number is valid. For instance, in one example of the operation 408, the login service searches a data structure that associates registration numbers with entry point identifiers generated during registration of client computers. This associative data structure can be stored, for instance, in a login data store (e.g., the login data store 334 of FIG. 3). In this example, where the login service finds an association (e.g., a record) in the data structure that includes a registration number that matches the extracted registration number, the login service determines 408 that the extracted registration number is valid and proceeds to operation 409. Where the login service does not find an association that includes a registration number that matches the extracted registration number, the login service determines 408 that the registration number is invalid, redirects the protected application to a registration service for the client computer (e.g., the registration service 336 of FIG. 3), and the process 400 ends.

Continuing with the process 400, the login service initiates 409 a login session. For instance, in one example, the login service initiates 409 the login session by generating a session identifier and storing the session identifier in the login data store. In some examples, the operation 409 also includes generating an expiration timestamp for the login session and storing the expiration timestamp in association with the session identifier in the login data store. In these examples, the login service can calculate the expiration timestamp by adding an expiration offset to the current time. Further, in certain examples, the operation 409 includes storing, in the login data store, an association between the session identifier, the entry point identifier identified via its association with the registration number in the operation 408, and an identifier (e.g., a uniform resource locator (URL)) of an application programming interface (API) endpoint implemented by the login service. The login agent can access this login API endpoint to request passwordless login, as is described below. The login service transmits 410 the entry point identifier and the identifier of the login API endpoint to the protected application.

Continuing with the process 400, the protected application receives 412 the entry point identifier and the API endpoint identifier. Next, the protected application controls the client computer to transmit 414, within a limited range, the entry point identifier and the API endpoint identifier via a signal that is detectable by the mobile device. This signal can be, for instance, a quick response (QR) code rendered on a display of the computer system; a personal area network signal, such as a BLUETOOTH signal; a local area network signal, such as a WI-FI signal; or a light-based signal, such as a Li-Fi signal. The limited range can be, for example, less than 10 feet, less than 30 feet, less than 50 feet, or less than 100 feet, to name a few ranges.

In some examples, the mobile device detects the signal upon entering the limited range (e.g., as a result of the user scanning the QR code). In these examples, the mobile device receives and decodes the signal to generate data specifying the entry point identifier and the API endpoint identifier and executes the login agent in response to identifying an association between the API endpoint identifier and the login agent. Optionally, the mobile device can also acquire an identifier of the client computer. This client computer identifier can take a variety of forms. For instance, in some examples, the client computer identifier is a GUID (or some other sequence of characters that is unique within a given namespace) encoded within a visual representation, such as a QR code, Code 39 barcode, or the like. In these examples, the visual representation of the client computer identifier can be affixed to, or be within a limited range of, the client computer, and the mobile device can acquire the client computer identifier by scanning the visual representation. Additional examples of client computer identifiers are further described below with reference to operation 669 of FIG. 6B.

Continuing with the process 400, the login agent optionally receives 415 the client computer identifier. Next, the login agent receives 416 the entry point identifier and the API endpoint identifier. The login agent determines 418 a number of user accounts registered to log in via the API endpoint using the mobile device. For instance, in one example, the login agent searches a data structure that associates API endpoint identifiers with identifiers of user accounts. This associative data structure can be stored, for instance, in an agent data store (e.g., the agent data store 312 of FIG. 3) and populated during execution of a registration process for the mobile device, as is described in detail below. In this example, where the login agent finds two or more associations (e.g., a records) in the data structure that include API endpoint identifiers that match the API endpoint identifier received in operation 416, the login agent determines 418 that two or more users are registered to log in via the API endpoint and proceeds to operation 422. Where the login agent finds only a single association that includes an API endpoint identifier that matches the received API endpoint identifier, the login agent determines 418 that one user is registered to log in at the API endpoint and proceeds to operation 420. Where the login agent finds no associations that includes an API endpoint identifier that matches the received API endpoint identifier, the login agent determines 418 that 0 users are registered to log in at the API endpoint identifier, redirects the protected application to a registration service for the mobile device, and the process 400 ends.

Continuing with the process 400, in operation 420, the login agent selects 420 a default user account identifier (e.g., the only user account identifier identified in the operation 418) and proceeds to operation 424. In the operation 422, the login agent prompts the user, via a user interface of the mobile device, to select one of the two or more user account identifiers identified in the operation 418 and receives input selecting one user account identifier.

Continuing with the process 400, the login agent transmits 424 a login request to the login service via the identified login API endpoint. The login request specifies the selected user account identifier, an identifier of the mobile device, and the entry point identifier. In examples that include the operation 415, the login request additionally includes the client computer identifier.

With reference to FIG. 4B, the process 400 continues with the login service receiving 426 the login request. Next, the login service determines 428 whether the received login request includes valid data. For instance, in some examples, the login service determines whether an association between the entry point identifier received in operation 426 and an unexpired session identifier exists in the login data store. Where no such association exists, the login service determines 426 that the login request is invalid. Where such an association exists, the login service determines (in examples that include the operation 415) whether an association between the entry point identifier and the client computer identifier exists in the login data store. Where no such association exists, the login service determines 426 that the login request is invalid. Where such an association exists, the login service determines whether an association between the entry point identifier and the API endpoint identifier exists in the login data store. Where no such association exists, the login service determines 428 that the login request is invalid. Where such an association exists, the login service determines whether the user account identifier, mobile device identifier, and login API endpoint identifier are a valid, registered combination. For instance, in some examples, the login service searches a data structure that associates API endpoint identifiers, mobile device identifiers, and user account identifiers. This associative data structure can be stored, for instance, in the login data store and be populated during execution of a registration process for the mobile device, as is described in detail below. In this example, where the login service finds an association (e.g., a record) in the data structure that includes a user account identifier, mobile device identifier, and entry point identifier that match the user account identifier, mobile device identifier and entry point identifier received in operation 426, the login service determines 428 that the received login request is valid and proceeds to operation 430. Where the login service does not find an association that includes a user account identifier, mobile device identifier, and entry point identifier that match the received user account identifier, mobile device identifier and entry point identifier, the login service determines 428 that the received login request is invalid, redirects the protected application to a registration service for the mobile device, and the process 400 ends.

Continuing with the process 400, the login service transmits 430, to the login agent, a response to the login request that specifies a nonce challenge. This nonce challenge may be, for example, a random number.

Continuing with the process 400, the login agent receives 432 the response to the login request, extracts the nonce challenge, and requests 434 a security chip (e.g., the security chip 322 of FIG. 3) of the mobile device to sign the nonce challenge with a private key owned by the user. The security chip, in turn, requests authentication (e.g., biometric authentication) of the user to ensure the user is the owner of the private key. Where the authentication of the user owner is successful, the security chip signs the nonce challenge to generate a signed response. Where the authentication of the user is not successful, the security chip refuses to sign the nonce challenge.

Continuing with the process 400, the login agent determines 436 whether the security chip signed the nonce challenge to generate the signed response. Where the login agent determines 436 that the signed response was not generated, the process 400 ends. Where the login agent determines 436 that the signed response was generated, the login agent transmits a completion request 438 to the login service. Data in the completion request specifies the signed response and the entry point identifier to the login service.

Continuing with the process 400, the login service receives 440 the signed response and the entry point identifier. Next, the login service determines 442 whether the entry point identifier and the signed response are valid. For instance, in one example, the login service determines whether an association between the entry point identifier and an unexpired session identifier exists in the login data store. Where no such association exists, the login service determines 442 that the entry point identifier and the signed response are invalid. Where such an association exists, the login service next determines whether an association between the unexpired session identifier and a mobile device identifier exists in the login data store. Where no such association exists, the login service determines 442 that the entry point identifier and the signed response are invalid. Where such an association exists, the login service next determines whether an association between the mobile device identifier and a public key exists in the login data store. This public key can be stored, for instance, in the login data store during execution of a registration process for the mobile device, as is described in detail below. Where no such association between the mobile device identifier and a public key exists in the login data store, the login service determines 442 that the entry point identifier and the signed response are invalid. Where such an association exists, the login service next attempts to verify the signed response using the public key. Where such verification fails, the login service determines 442 that the entry point identifier and the signed response are invalid. Where the login service verifies that the signed response was generated using the original nonce challenge and the private key, the login service determines 442 that the entry point identifier and the signed response are valid.

Where the login service determines 442 that the signed response is invalid, the process 400 ends. Where the login service determines 442 that the signed response is valid, the login service transmits 444 a response to the completion request to the login agent. The response includes an acknowledgement indicating login is successful. The login agent receives 446 and processes the completion response.

Continuing with the process 400, the login service transmits 448 a login command to the protected application. Where the protected application includes a browser, the login command may take the form of a login cookie. Alternatively or additionally, the login command can be a web page with hypertext markup language or JavaScript commands that redirect the browser to a logged-in page.

Continuing with the process 400, the protected application receives 450 the login command and logs 452 the selected user account identifier into the protected application, thereby unlocking the protected application and providing the user with access authorized for the user account identified by the user account identifier. Subsequent to operation 452, the process 400 ends.

It should be noted that entry points other than a web page can be employed within the process 400. For instance, in some examples of the process 400, the entry point is a guard application distinct from the protected application that runs natively under the same operating system as the protected application. Additionally or alternatively, the entry point can be a control implemented by a library linked to the protected application at runtime. In still another example, the entry point is a component interpreted by a proprietary runtime engine. As illustrated by these examples, the entry point utilized within the process 400 is not limited to a particular type of executable or container.

As explained above, in certain examples a passwordless login system (e.g., the system 300 of FIG. 3) executes one or more registration processes to enable mobile devices and client computers to participate in passwordless logins. FIGS. 5A-5C illustrate a registration process 500 executed by a passwordless login system in some examples. As shown in FIGS. 5A-5C, the process 500 is executed by a registration agent (e.g., the registration agent 316 of FIG. 3), a protected application (e.g., the protected application 116 of FIGS. 1 and 3), and a registration service (e.g., the registration service 336 OF FIG. 3). The registration agent is hosted by a mobile device (e.g., the mobile device 302 of FIG. 3). The protected application is hosted by a client computer (e.g., the client computer 304 of FIG. 3). The registration service is hosted by a server computer (e.g., the server computer 308 of FIG. 3). The registration process 500 registers the mobile device and a user account for use in the passwordless login system.

With reference to FIG. 5A, the process 500 starts with a protected application receiving 502 input specifying user security credentials (e.g. an identifier of the user and a password). The protected application may be, for example, a browser-based application served by the registration service, a digital workspace client, or the like. In response to receiving the user's security credentials, the protected application transmits 504 a request for a registration session to the registration service. For example, the protected application may transmit 504 the registration session request to a registration API endpoint implemented by the registration service. The registration session request specifies the security credentials of the user.

Continuing with the process 500, the registration service receives 506 the registration session request. In response to receiving the registration session request, the registration service parses the request, extracts the security credentials, and determines 508 whether the security credentials are valid. For instance, in one example of the operation 508, the registration service searches a data structure that associates user account identifiers with valid passwords. This associative data structure can be stored, for instance, in a registration data store (e.g., the registration data store 340 of FIG. 3). In this example, where the registration service finds an association (e.g., a record) in the data structure that includes a user account identifier and password that match the user account identifier and password received in the registration session request, the login service determines 508 that the security credentials are valid and proceeds to operation 510. Also in this example, where the registration service does not find an association that includes a user account identifier and password that match the user account identifier and password received in the registration session request, the registration service determines 508 that the security credentials are invalid and the process 500 ends. It should be noted that, in some examples, the registration service determines 508 validity of the security credentials by calling an identity API and receiving a response thereto that indicates whether the security credentials are valid.

Continuing with the process 500, the registration service identifies a user account based on the security credentials and initiates 510 a registration session in association with the user account. For instance, in one example, the registration service initiates 510 the registration session by generating a random number or other identifier and storing (e.g., in the registration data store) the random number as a registration token in association with the user account identifier associated with the user account and the security credentials. In some examples, the operation 510 also includes generation of an expiration timestamp for the registration session and storing the expiration timestamp in association with the registration token. In certain examples, the registration service calculates the expiration timestamp by adding an expiration offset to the current time. Next, the registration service transmits 512 a response to the registration session request. This response includes the token and an identifier (e.g., a URL) of a registration API endpoint implemented by the registration service through which the registration agent can request continuation of the registration process.

Continuing with the process 500, the protected application receives 514 the response to the registration session request and parses the response to extract the token and the API endpoint identifier specified therein. Next, the protected application transmits 516 the token and the API endpoint identifier via a signal with limited range that is detectable by the mobile device. This signal can be, for instance, a quick response (QR) code rendered on a display of the computer system; a personal area network signal, such as a BLUETOOTH signal; a local area network signal, such as a WI-FI signal; or a light-based signal, such as a Li-Fi signal.

Continuing with the process 500, the mobile device detects the signal upon entering the limited range (e.g., as a result of the user scanning the QR code). The mobile computing device receives and decodes the signal to generate data specifying the token and the API endpoint identifier and executes the registration agent in response to identifying an association between the generated data (e.g., the API endpoint identifier) and the registration agent. The registration agent receives 518 the generated data and parses the generated data to extract the token and the API endpoint identifier.

Continuing with the process 500, the registration agent requests 520 secure generation (e.g., via the security chip 322 of FIG. 3 embedded within the mobile device) of a public/private key pair. The security chip, in turn, requests biometric authentication of the user to establish the user as the owner of the public/private key pair. Where the biometric authentication of the user is successful, the security chip generates the public/private key pair and stores an association between a unique biometric identifier of the user and the public/private key pair. This association may be stored, for example, in a secure data store (e.g., the secure data store 320 of FIG. 3). Where the biometric authentication of the user is not successful, the security chip refuses to generate the public/private key pair.

Continuing with the process 500, the registration agent determines 522 whether the security chip generated the public/private key pair. Where the registration agent determines 522 that the public/private key pair was not generated, the process 500 ends. Where the registration agent determines 522 that the public/private key pair was generated, the registration agent proceeds to operation 524.

Continuing with the process 500, the registration agent generates and transmits 524 a request to continue the registration session. The request specifies an identifier of the mobile device, the token, and the public key generated by the mobile device.

Continuing with the process 500, the registration service receives 526 the request to continue the registration session and parses the request to extract the mobile device identifier, the token, and the public key. Next, with reference to FIG. 5B, the registration service determines 528 whether the received registration token is valid. In some examples, the registration service makes this determination by searching a data structure that associates previously generated registration tokens with expiration timestamps. This associative data structure can be stored, for instance, in the registration data store and be populated during execution of the operation 510. In this example, where the registration service finds an association (e.g., a record) in the data structure that includes an unexpired registration token that matches the token received in the continuation request, the registration service determines 528 that the received token is valid, stores an association between the public key, the mobile device identifier, and the registration session (e.g., via the registration token) in the registration data store, and proceeds to operation 530. Where the registration service does not find an association that includes an unexpired registration token that matches the token received in the continuation request, the registration service determines 528 that the received token is not valid, and the process 500 ends.

Continuing with the process 500, the registration service generates a security code (e.g., a four digit code), associates the security code with the registration session and transmits 530, to the registration agent, a response to the continuation request. The response specifies the security code and the registration token. In some examples, the registration service associates the security code with the registration session by storing an association between the registration token and the security code in the registration data store.

Continuing with the process 500, the registration agent receives 532 the response and parses the response to extract the security code and the registration token. Next, the registration agent prompts 534 the user to respond to the user interface of the protected application and to interact with the registration agent (e.g., push a button labeled “continue”) subsequent to responding to the protected application. Concurrently, the registration service transmits 536 a request to the protected application to prompt the user to enter the security code and the user's security credentials. This request includes the token.

Continuing with the process 500, the protected application prompts 538 the user to enter the security code and, in some examples, the user's security credentials. Next, the protected application interacts with the user to receive 540 input specifying the security code and, in some examples, the security credentials. The protected application transmits 542 the token, the security code, and any security credentials received to the registration service. The registration service receives 544 the token, the security code, and the security credentials from the protected application.

Continuing with the process 500, the registration agent receives 546 the requested input. In response, the registration agent requests 548 that the security chip utilize a private key owned by the user to sign the security code. The security chip, in turn, requests authentication (e.g., biometric authentication) of the user to ensure the user is the owner of the private key. Where the authentication of the user is successful, the security chip signs the security code to generate a signed security code. Where the authentication of the user is not successful, the security chip refuses to sign the security code, and the process 500 ends.

Continuing with the process 500, the registration agent determines 550 whether the security chip signed the security code to generate the signed security code. Where the registration agent determines 550 that the signed security code was not generated, the process 500 ends. Where the registration agent determines 550 that the signed security code was generated, the registration agent transmits 552 another request to continue the registration session. This continuation request includes the user account identifier, the token, and the signed security code.

Continuing with the process 500, the registration service receives 554 the continuation request. Next, the registration service determines 556 whether the messages received in the operations 544 and 554 include valid data. For instance, in some examples, the registration service determines that the security credentials, security code, and registration token received in operation 544 are valid where an association between the received security credentials, security code, and registration token is stored in the registration data store. Where no such association is stored in the registration data store, the registration service determines that the security credentials, security code, or token received in operation 544 are invalid. Moreover, in some examples, the registration service determines that the token, user account identifier, and signed security code received in the operation 554 are valid where an association between the token and the user account identifier exists within the registration data store and where the registration service successfully verifies the signed security code using the public key associated with the user account identifier. In these examples, the registration service determines that the token, user account identifier, and signed security code received in the operation 554 are invalid where no association between the token and the user account identifier exists within the registration data store or where the registration service is unable to verify the signed security code using the public key associated with the user account identifier. Where the registration service determines 556 the messages received in the operations 544 and 554 include valid data, the registration proceeds to operation 558. Where the registration service determines messages received in the operations 544 and 554 do not include valid data, the process 500 ends.

With reference to FIG. 5C, the process 500 continues with the registration service generating and transmitting 558, to the registration agent, a response to the continuation request. Data in the response specifies the token, the user account identifier, and an identifier of a login API endpoint through which the identified user can log in without a password.

Continuing with the process 500, the registration agent receives 560 the response and parses the response to extract the user account identifier, the identifier of the login API endpoint, and the token. Next, the registration agent stores an association 562 between the user account identifier and the identifier of the login API endpoint in an agent data store (e.g., the agent data store 312 of FIG. 3), so that the identified user can subsequently log in via the login API endpoint using the mobile device. The registration agent generates and transmits 564, to the registration service, a request to complete the registration session. This request includes the registration token.

Continuing with the process 500, the registration service receives 566 the request to complete the registration session and parses the request to extract the token. Next, the registration service determines 568 whether the received registration token is valid. In some examples, the registration service makes this determination by searching a data structure that associates previously generated registration tokens with expiration timestamps. This associative data structure can be stored, for instance, in the registration data store and be populated during execution of the operation 510. In this example, where the registration service finds an association (e.g., a record) in the data structure that includes an unexpired registration token that matches the token received in the continuation request, the registration service determines 568 that the received token is valid, stores an association between the public key, the mobile device identifier, and the registration session (e.g., via the registration token) in the registration data store, and proceeds to operation 570. In some examples, the registration service also stores an association between the public key and the user account identifier, to enable passwordless login for multiple users via the same mobile device. Where the registration service finds an association that includes an expired registration token that matches the token received in the continuation request, the registration service determines 568 that the received token is not valid, and the process 500 ends.

Continuing with the process 500, the registration service marks the mobile device as being ready to use with the user account by storing an association 570 between the mobile device identifier, the user account identifier, and the identifier of the login API endpoint in the registration data store. Next the registration service generates and transmits 572, to the registration agent, a response to the completion request that indicates success and completes the registration session. For instance, in some examples, the registration service completes the registration session by storing an indication of the same in the registration data store. The registration agent receives 574 and processes the completion request.

It should be noted that, in some examples, upon completion of the registration process 500, the registration service copies the various associations and other data created during the registration process to a login data store (e.g., the login data store 334 of FIG. 3) to enable the login service to successfully process passwordless login requests from registered devices.

As described above, the registration service uses the security code and associated second security credential-based authentication as a countermeasure against at least one type of attack that can be attempted by a malicious actor. More specifically, during a registration session, the malicious actor might entice (e.g., via phishing) the user to visit a site controlled by the malicious actor through a mobile device. When this attack occurs, the registration service communicates with the malicious actor's smartphone instead of the user's smartphone. However, the user is not aware of this fact, and believes the user's mobile device is communicating with the registration service. If the registration service did not require the security code and the associated second security credential-based authentication, the malicious actor could successfully impersonate the user through the remainder of the registration process. To foil this type of attack, the registration service described herein utilizes the security code described above.

As explained above, in certain examples a passwordless login system (e.g., the system 300 of FIG. 3) executes one or more registration processes to enable mobile devices and client computers to participate in passwordless logins. FIG. 6A illustrates a registration process 600 executed by a passwordless login system in some examples. As shown in FIG. 6A, the process 600 is executed by a protected application (e.g., the protected application 116 of FIGS. 1 and 3) and a registration service (e.g., the registration service 336 OF FIG. 3). The protected application is hosted by a client computer (e.g., the client computer 304 of FIG. 3). The registration service is hosted by a server computer (e.g., the server computer 308 of FIG. 3). The registration process 600 registers the client computer and protected application for use in the passwordless login system.

With reference to FIG. 6A, the process 600 starts with the protected application receiving 602 input requesting registration of the client computer and protected application for passwordless logins. For instance, in one example, the protected application receives input navigating the protected application to a web page that is an entry point to the requested registration process.

Continuing with the process 600, the client computer transmits 604 a request for access to an entry point to the registration process. For instance, in one example, the protected application transmits a request to be served the web page specified by the input received in operation 602.

Continuing with the process 600, the registration service receives 606 the entry point request and parses the request. In response, the registration service transmits 608 the requested entry point to the protected application. For instance, in one example, the registration service serves the web page to the protected application.

Continuing with the process 600, the protected application receives 610 the response including the entry point, parses the response, and loads the entry point. For instance, in one example, the protected application loads the web page.

Continuing with the process 600, the protected application prompts 612 the user to enter security credentials. For instance, in one example, the web page can include controls that request the user's user account identifier and password.

Continuing with the process 600, the protected application receives 614 the security credentials requested in operation 612. For instance, in one example, the protected application receives input, via a user interface, specifying the security credentials.

Continuing with the process 600, responsive to reception of the user's security credentials, the protected application transmits 615 a request to register the client computer and protected application to support passwordless login processes. The request can include, for example, data specifying the security credentials received in the operation 614.

Continuing with the process 600, the registration service receives 616 the registration request from the protected application and parses the request. In response to reception of the request, the registration service determines 618 whether the request is valid by, for example, authenticating the security credentials specified therein with an identity service. Where the request is invalid, the process 600 ends. Where the request is valid, the registration service proceeds to operation 620.

Continuing with the process 600, the registration service generates 620 a registration number and an entry point identifier. The registration number and the entry point identifier can be, for example, GUIDs. The registration number acts as an external identifier of the entry point. The entry point identifier acts as an internal identifier of the entry point.

Continuing with the process 600, the registration service stores 622 an association between the registration number and the entry point identifier in a data store (e.g., the registration data store 340 of FIG. 3). Next, the registration service transmits 624 the registration number to the protected application. In at least some examples, the registration service embeds the registration number in a cookie.

Concluding the process 600, the protected application receives and locally stores 626 the registration number, and the process 600 ends.

It should be noted that, in some examples, upon completion of the registration process 600, the registration service copies the various associations and other data created during the registration process to a login data store (e.g., the login data store 334 of FIG. 3) to enable the login service to successfully process passwordless login requests from registered devices.

As explained above, in certain examples a passwordless login system (e.g., the system 300 of FIG. 3) executes one or more registration processes to enable mobile devices and client computers to participate in passwordless logins. FIGS. 6B-6C illustrate a registration process 650 executed by a passwordless login system in some examples. As shown in FIGS. 6B-6C, the process 650 is executed by a registration agent (e.g., the registration agent 350 of FIG. 3), a registered client application (e.g., a browser or digital workspace client executing on a registered computer system), and a registration service (e.g., the registration service 336 OF FIG. 3). The registration agent is hosted by a client computer (e.g., the client computer 304 of FIG. 3). The registered client is hosted by a client computer (e.g., like the client computer 304 of FIG. 3). The registration service is hosted by a server computer (e.g., the server computer 308 of FIG. 3). The registration process 650 registers the client computer for use in the passwordless login system.

With reference to FIG. 6B, the process 650 starts with a registered client receiving 652 input specifying user security credentials (e.g. an identifier of the user and a password). In response to receiving the user's security credentials, the registered client transmits 654 a request for a registration session to the registration service. For example, the registered client may transmit 654 the registration session request to a registration API endpoint implemented by the registration service. The registration session request specifies the security credentials of the user.

Continuing with the process 650, the registration service receives 656 the registration session request. In response to receiving the registration session request, the registration service parses the request, extracts the security credentials, and determines 658 whether the security credentials are valid. For instance, in one example of the operation 658, the registration service searches a data structure that associates user account identifiers with valid passwords. This associative data structure can be stored, for instance, in a registration data store (e.g., the registration data store 340 of FIG. 3). In this example, where the registration service finds an association (e.g., a record) in the data structure that includes a user account identifier and password that match the user account identifier and password received in the registration session request, the login service determines 658 that the security credentials are valid and proceeds to operation 660. Also in this example, where the registration service does not find an association that includes a user account identifier and password that match the user account identifier and password received in the registration session request, the registration service determines 658 that the security credentials are invalid and the process 650 ends. It should be noted that, in some examples, the registration service determines 658 validity of the security credentials by calling an identity API and receiving a response thereto that indicates whether the security credentials are valid.

Continuing with the process 650, the registration service identifies a user account based on the security credentials and initiates 660 a registration session in association with the user account. For instance, in one example, the registration service initiates 660 the registration session by generating a random number or other identifier and storing (e.g., in the registration data store) the random number as a session identifier in association with the user account identifier associated with the user account and the security credentials. In some examples, the operation 660 also includes generation of an expiration timestamp for the registration session and storing the expiration timestamp in association with the session identifier. In certain examples, the registration service calculates the expiration timestamp by adding an expiration offset to the current time. Next, the registration service transmits 662 a response to the registration session request. This response includes the session identifier and an identifier (e.g., a URL) of a registration API endpoint implemented by the registration service through which the registration agent can request continuation of the registration process.

Continuing with the process 650, the registered client receives 664 the response to the registration session request and parses the response to extract the session identifier and the API endpoint identifier specified therein. Next, the registered client transmits 666 the session identifier and the API endpoint identifier via a signal with limited range that is detectable by the client computer. This signal can be, for instance, a quick response (QR) code rendered on a display of the computer system; a personal area network signal, such as a BLUETOOTH signal; a local area network signal, such as a WI-FI signal; or a light-based signal, such as a Li-Fi signal.

Continuing with the process 650, the client computer detects the signal upon entering the limited range (e.g., as a result of the user scanning the QR code). The client computer receives and decodes the signal to generate data specifying the session identifier and the API endpoint identifier and executes the registration agent in response to identifying an association between the generated data (e.g., the API endpoint identifier) and the registration agent. The registration agent receives 668 the generated data and parses the generated data to extract the session identifier and the API endpoint identifier.

Continuing with the process 650, the registration agent optionally receives 669 an identifier of the client computer that can be externally detected by another computing device within a limited range of the client computer. This client computer identifier can take a variety of forms. For instance, in some examples, the client computer identifier is an internet protocol address or media access control address of the client computer that can be detected via network communications with the client computer. Additionally or alternatively, the client computer identifier can be a GUID (or some other sequence of characters that is unique within a given namespace) encoded within a visual representation, such as a QR code, Code 39 barcode, Li-Fi signal, or the like. In these examples, the visual representation of the client computer identifier can be affixed to, or be within a limited range of, the client computer. Further, in these examples, a camera of the client computer (or a computing device in communication with the client computer, such as a scanner or a smartphone) scans the visual representation of the client computer identifier and passes the client computer identifier to the registration agent. Additionally or alternatively, the client computer identifier can originate from devices other than the client computer, such as via a WI-FI signal, a BLUETOOTH signal, or the like transmitted by a computing device within a limited range of the client computer. For instance, in some examples, the client computer identifier can include one or more values encoded within various bi-directional communication protocols (e.g., WI-FI, BLUETOOTH, Li-Fi, or the like). It should be noted that these values can be acquired without the detecting device (e.g. a smartphone or the client computer) establishing a bi-directional communication session. For instance, in these examples, the registration agent could receive a client computer identifier made up of values from two or three BLUETOOTH signals from nearby keyboards, iBeacons and values from one or more nearby WI-FI access points.

Continuing with the process 650, the registration agent requests 670 secure generation (e.g., via the security chip 344 of FIG. 3 embedded within the client computer) of a public/private key pair. The security chip, in turn, requests biometric authentication of the user to establish the user as the owner of the public/private key pair. Where the biometric authentication of the user is successful, the security chip generates the public/private key pair and stores an association between a unique identifier (e.g., a biometric identifier) of the user and the public/private key pair. This association may be stored, for example, in a secure data store (e.g., the secure data store 342 of FIG. 3). Where the authentication (e.g., biometric authentication) of the user is not successful, the security chip refuses to generate the public/private key pair.

Continuing with the process 650, the registration agent determines 672 whether the security chip generated the public/private key pair. For instance, in one example, the registration agent receives a response to the generation request that indicates success and that includes a copy of the public key. Where the registration agent determines 672 that the public/private key pair was not generated, the process 650 ends. Where the registration agent determines 672 that the public/private key pair was generated, the registration agent proceeds to operation 674.

With reference to FIG. 6C, the process 650 continues with the registration agent generating and transmitting 674 a request to continue the registration session via the API endpoint. The request specifies an identifier of the client computer (e.g., the client computer identifier described above or an internally accessible identifier, such as a device serial number), the session identifier, and the public key generated by the client computer.

Continuing with the process 650, the registration service receives 676 the request to continue the registration session and parses the request to extract the client computer identifier, the session identifier, and the public key. Next, the registration service determines 678 whether the received session identifier is valid. In some examples, the registration service makes this determination by searching a data structure that associates previously generated session identifiers with expiration timestamps. This associative data structure can be stored, for instance, in the registration data store and be populated during execution of the operation 660. In this example, where the registration service finds an association (e.g., a record) in the data structure that includes an unexpired registration session identifier that matches the session identifier received in the continuation request, the registration service determines 678 that the received session identifier is valid, stores an association between the public key, the client computer identifier, and the registration session (e.g., via the session identifier) in the registration data store, and proceeds to operation 680. Where the registration service finds an association that includes an expired session identifier that matches the session identifier received in the continuation request, the registration service determines 678 that the received session identifier is not valid, and the process 650 ends.

Continuing with the process 650, the registration service transmits 680 an acknowledgment of the continuation request. The acknowledgement includes the session identifier.

Continuing with the process 650, the registration agent receives 682 the acknowledgement and parses the acknowledgement to extract the session identifier. Next, the registration agent generates 684 a shared secret (e.g., a random number) and requests 686 that the security chip utilize a private key owned by the user to sign the shared secret. The security chip, in turn, requests authentication (e.g., biometric authentication) of the user to ensure the user is the owner of the private key. Where the authentication of the user owner is successful, the security chip signs the shared secret to generate a signed shared secret. Where the authentication of the user is not successful, the security chip refuses to sign the shared secret.

Continuing with the process 650, the registration agent determines 688 whether the security chip signed the shared secret to generate the signed shared secret. For instance, in one example, the registration agent receives a response to the signature request that indicates success and that includes a copy of the signed shared secret. Where the registration agent determines 688 that the signed shared secret was not generated, the process 650 ends. Where the registration agent determines 688 that the signed shared secret was generated, the registration agent transmits 690 another request to complete the registration session. This completion request includes the client computer identifier, the session identifier, and the signed shared secret.

Continuing with the process 650, the registration service receives the completion request 692 and parses the request to extract the client computer identifier, the session identifier and the signed shared secret. Next, the registration service determines 694 whether the completion request is valid. For instance, in some examples, the registration service determines whether the session identifier is valid using the process described above in operation 678. Where the session identifier is valid, the registration service attempts to verify the signed shared secret using the public key associated with the client computer identifier. Where the registration service determines that the session identifier is valid and verifies the signed shared secret, the registration service determines 694 that the completion request is valid and proceeds to operation 696. Where the registration service determines that the session identifier is invalid or is unable to verify the signed shared secret, the registration service determines 694 that the completion request is invalid, and the process 650 ends.

With reference to FIG. 6D, the process 650 continues with the registration service generating 696 a registration number and an entry point identifier. The registration number and the entry point identifier can be, for example, GUIDs. The registration number acts as an external identifier of the entry point. The entry point identifier acts as an internal identifier of the entry point.

Continuing with the process 650, the registration service stores 697 an association between the registration number, the entry point identifier, and the shared secret in the registration data store. In examples that include the operation 669, the registration service also stores an association between the client computer identifier and the entry point identifier in the registration data store. Next, the registration service transmits 698 the registration number to the protected application. In at least some examples, the registration service embeds the registration number in a cookie.

Concluding the process 650, the protected application receives and locally stores 699 the registration number, and the process 650 ends.

It should be noted that, in some examples, upon completion of the registration process 650, the registration service copies the various associations and other data created during the registration process to a login data store (e.g., the login data store 334 of FIG. 3) to enable the login service to successfully process passwordless login requests from registered devices. Additionally, where the passwordless login system uses a process such as the process 650 to register client computers, beneficial security enhancements to the operations 404 through 408 of the login process 400 illustrated in FIGS. 4A and 4B can be incorporated. For instance, prior to transmitting the registration number within the operation 404, the protected application 116 can utilize the security chip within the client computer to sign, securely with its private key, the locally stored shared secret and transmit the signed shared secret along with the registration number. Further, in these examples, the login service can receive 406 the signed shared secret and the registration number and identify the public key for the client computer using the registration number. The login service can also determine 408 validity based on validity of the registration number and verification of the signed shared secret using the public key for the client computer. Using the cryptographic components of the client computer in this way increases the overall security of the passwordless login system.

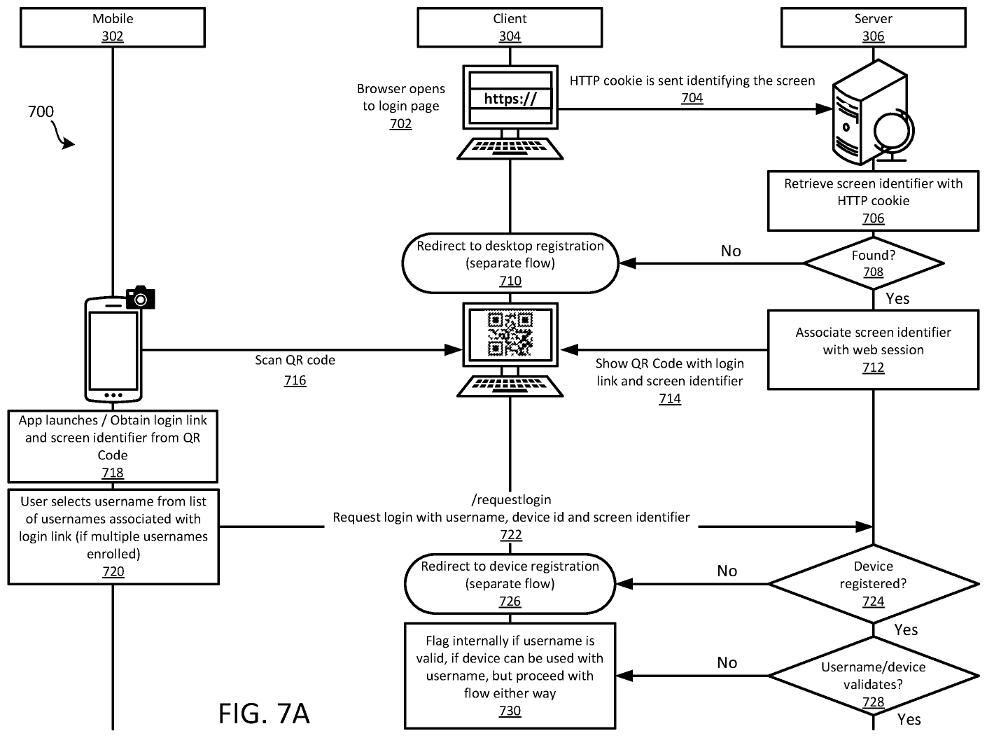

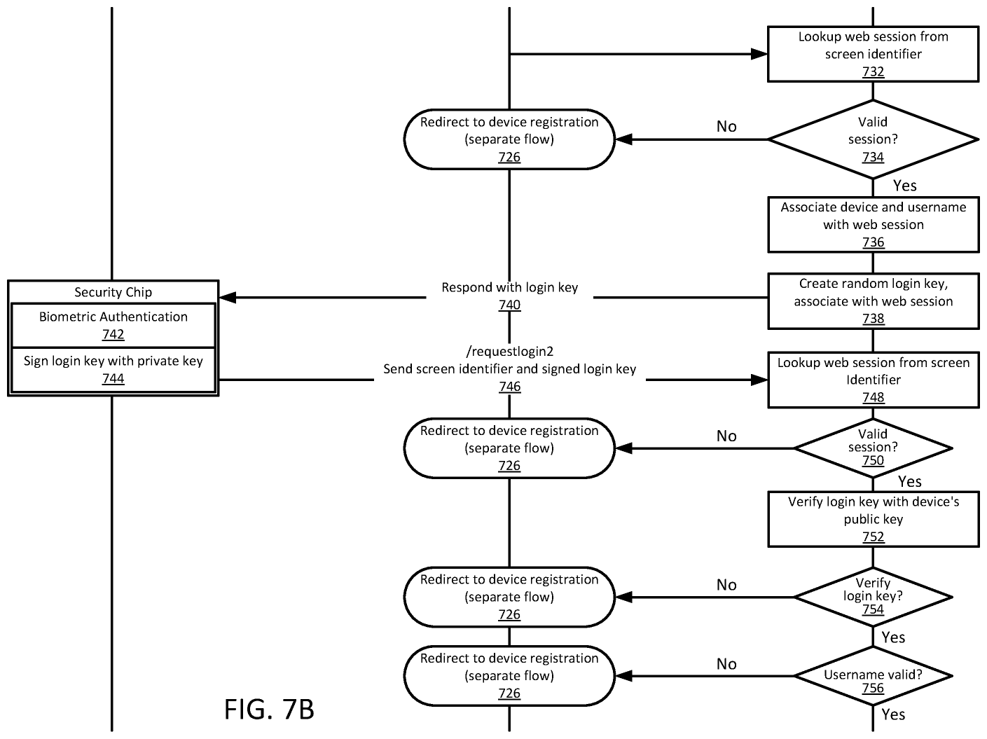

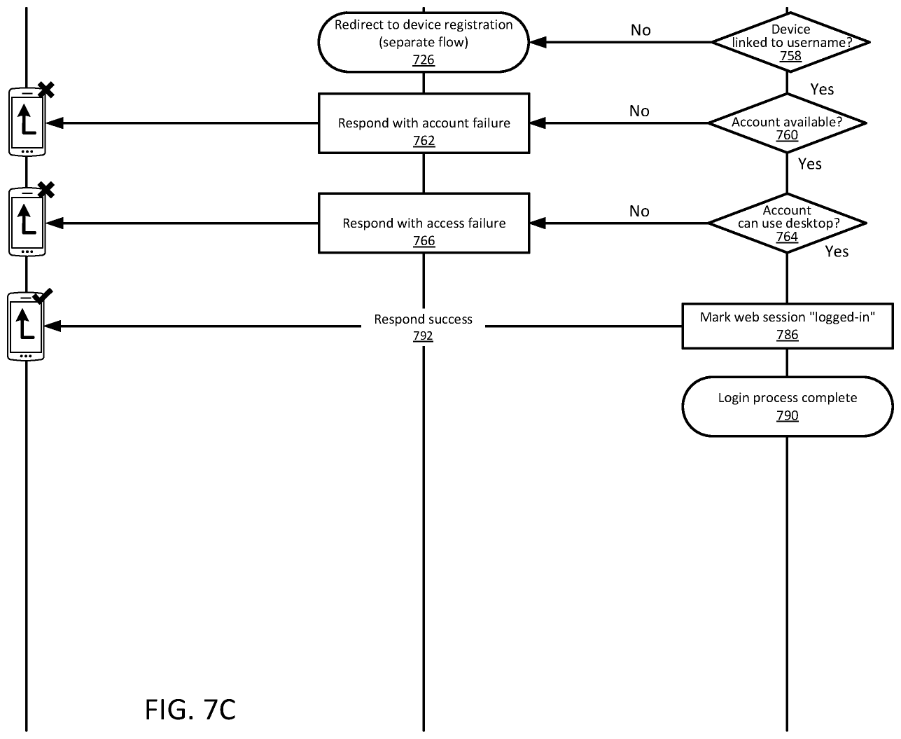

FIG. 7 illustrates another passwordless login process 700 executed by a passwordless login system (e.g., the system 300 of FIG. 3). As shown in FIG. 7, the process 700 starts with a browser hosted by a client computer system (e.g., the client computer system 304 of FIG. 3) opening 702 a login page served to the browser by a login service (e.g., the login service 330 of FIG. 3). The login service may be hosted, for example, by a server (e.g., the server computer system 306 of FIG. 3). During load of the login page, the browser sends 704 a hypertext transfer protocol (HTTP) cookie to the login service. The login service receives the cookie and attempts to retrieve 706 a screen identifier therefrom. Where the login service does not find 708 a screen identifier within the cookie, the login service redirects 710 the browser to a client computer registration page.

Where the login service finds 708 a screen identifier within the cookie, the login service initiates a web session and stores 712 an association between the screen identifier and an identifier of the web session. The login service encodes the screen identifier and a login link (e.g., a URL of an API endpoint implemented by the login service) into a QR code and serves a page to the browser that includes the QR code. The browser displays 714 the QR code.

Subsequently, a mobile computing device (e.g., the mobile computing device 302 of FIG. 3) scans 716 the QR code. The mobile computing device decodes the QR code and launches 718 a login agent that is associated with the login link. The login agent decodes the QR code to obtain the screen identifier and the login link. Next, the login agent determines a number of users who have registered to log in via the login link using the mobile computing device. For instance, in one example, the login agent searches a local data store (e.g., the agent data store 312 of FIG. 3) that associates usernames with login link identifiers. In this example, the login agent retrieves associations (e.g., records) from the local data store that include identifiers of the login link. Where more than one username is stored in the retrieved records, the login agent prompts the user, via a user interface of the mobile computing device, to select 720 a username associated with an account of the user. In this way, a user can log in under user accounts with different levels of authority. Where only a single username is stored in the retrieved records, the login agent selects 720 that username by default. The login agent transmits 722 a login request to the login service. The login request specifies the username, the screen identifier, and an identifier of the mobile computing device (e.g., a serial number, network address, globally unique identifier, or the like).

The login service determines 724 whether the mobile computing device is registered. For instance, in one example, the login service searches a login data store (e.g., the login data store 330 of FIG. 3) that lists identifiers of registered mobile computing devices for a record that includes the identifier of the mobile computing device. Where no such record is found, the login service determines 724 that the mobile computing device is not registered and redirects 726 the browser to a mobile computing device registration page. Where such a record is found, the login service determines 724 that the mobile computing device is registered and proceeds to operation 728.

In the operation 728, the login service determines 728 whether the mobile computing device and the username are setup within the overall system. For instance, in one example, the login service interoperates (via an API) with an identity provider/directory service to determine whether the mobile computing device and the username have been setup in the identity provider/directory service. If not, the process 700 ends. Otherwise, the login service determines if the mobile computing device is registered to log in the user identified by the selected username. For instance, in one example, the login service searches the login data store for an association, within a data structure that associates registered mobile computing devices with registered usernames, for an association (e.g., a record) that includes the username and the identifier of the mobile computing device. Where the login service finds such an association, the login service proceeds to operation 732. Where the login service does not find such an association, the login service flags 730 (e.g., records in the login data store) the status of both entities and proceeds to the operation 732.

With reference to FIG. 7B, the process 700 continues with the login service looking up 732, within the login data store, a web session identifier that is associated with the screen identifier specified by the login request. Next, the login service determines 734 whether the identified web session is valid (e.g., exists in the login data store and has not expired). If not, the login service redirects 726 the browser to a mobile computing device registration page. Otherwise, the login service stores 736 an association between the mobile device and the username in the login data store. Next, the login service creates 738 a random login key and stores an association between the login key and the web session identifier in the login data store. The login service responds 740 to the login request by transmitting the screen identifier and the login key to the login agent.

Continuing with the process 700, the login agent utilizes the mobile computing device's security chip (e.g., the security chip 322 of FIG. 3) to biometrically authenticate 742 the user and sign 744 the login key with the user's private key. Next, the login agent transmits 746 another login request to the login service. This login request includes data specifying the screen identifier and the signed login key.

Continuing with the process 700, the login service receives the login request and looks up 748, within the login data store, a web session identifier that is associated with the screen identifier specified by the login request. Next, the login service determines 750 whether the identified web session is valid (e.g., exists in the login data store and has not expired). If not, the login service redirects 726 the browser to a mobile computing device registration page.

Otherwise, the login service attempts to verify 752 the signed login key with the device's public key. If the login service is unable to verify 754 the signed login key, the login service redirects 726 the browser to a mobile computing device registration page. If the login service verifies 754 the signed login key, the login service determines 756 whether the username is valid. For instance, in one example, the login service determines whether the username has a registered entry in the login data store. If not, the login service redirects 726 the browser to a mobile computing device registration page. Otherwise, the login service proceeds to operation 758.

With reference to FIG. 7C, the process 700 continues with the login service determining 758 whether the mobile computing device is linked with the username. For instance, in one example, the login service determines whether an association between the mobile computing device identifier and the username exists in the login data store. If not, the login service redirects 726 the browser to a mobile computing device registration page. Otherwise, the login service determines 760 whether the user account associated with the username is available. For instance, in one example, the login service interoperates with a directory service to determine whether the user account associated with the username is in good standing and not currently in use. If not, the login service responds 762 to the login agent with a message that indicates the login process 700 failed due to an account failure. Otherwise, the login service determines 764 whether the user account associated with the username can be used with the client computer. For instance, in one example, the login service interoperates with a directory service to determine whether the user account associated with the username is authorized to use the client computer. If not, the login service responds 766 to the login agent with a message that indicates the login process 700 failed due to an access failure. Otherwise, the login service marks 786 the web session as “logged-in” (e.g., via interoperation with a directory service), responds 792 to the login agent with a message that indicates the login process 700 succeeded, and stores 790 (e.g., in the login data store) an indication that the login process 700 is complete.

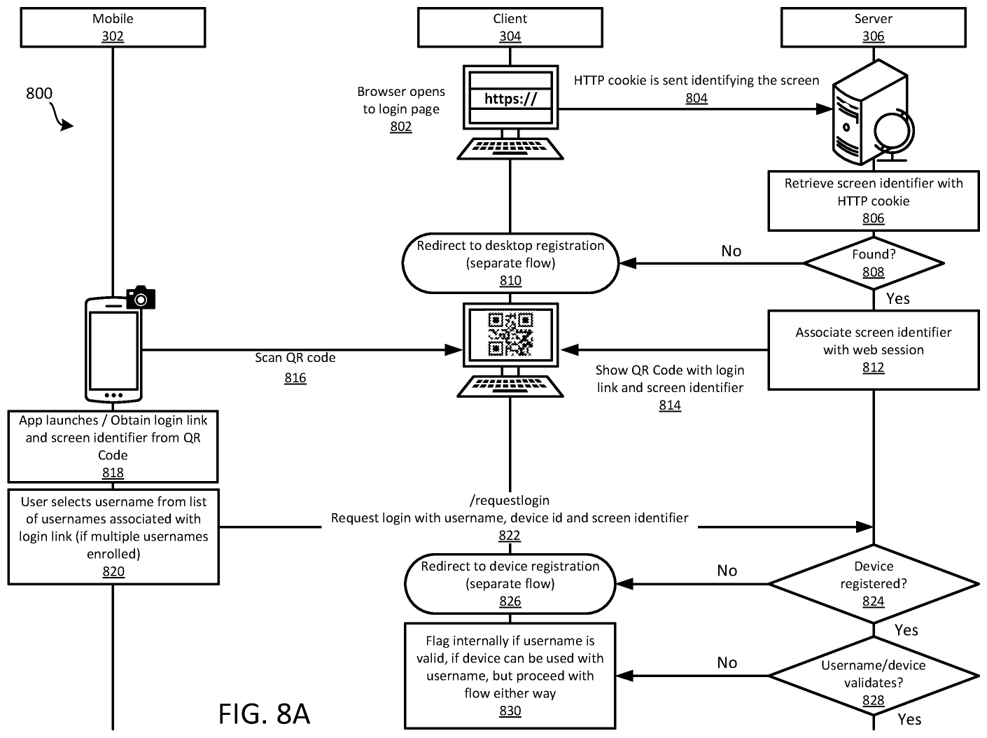

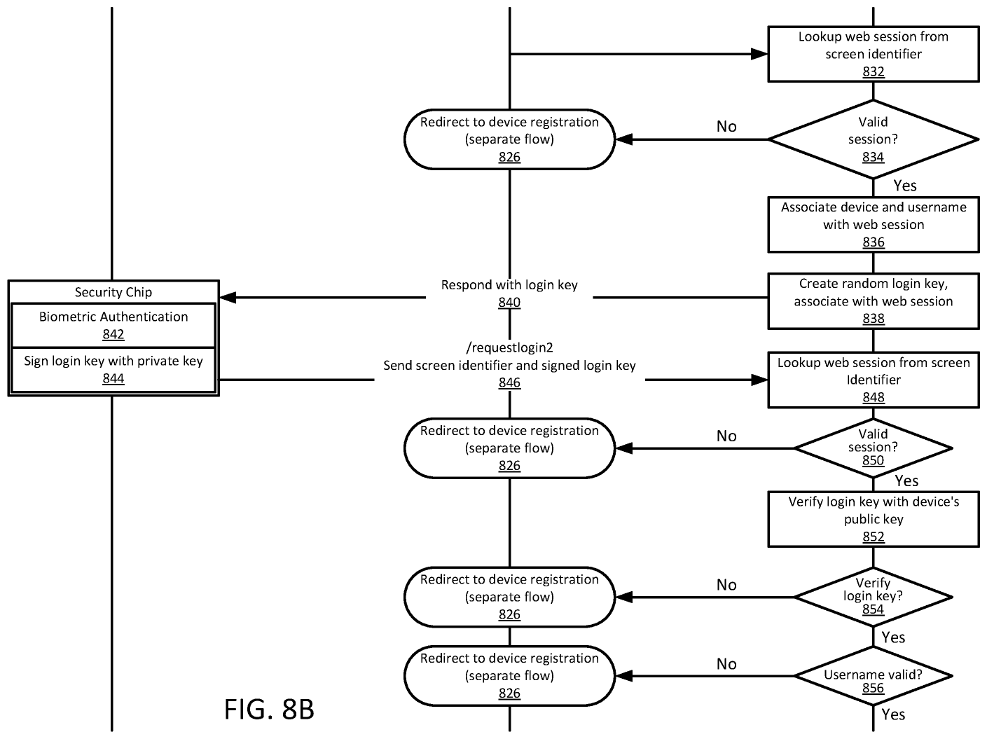

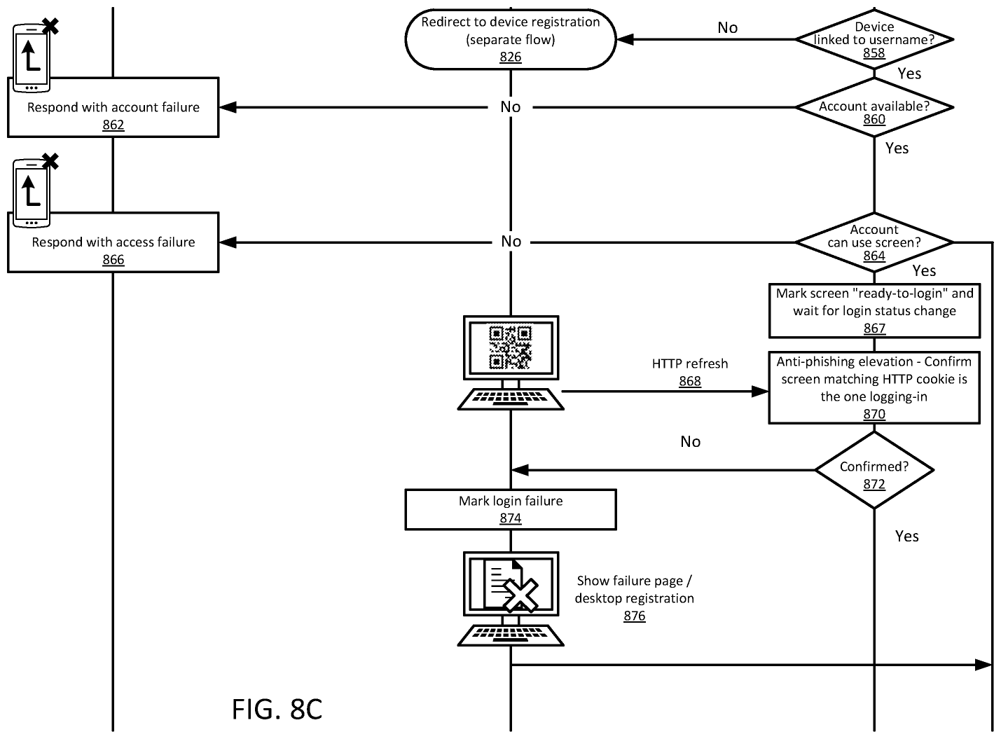

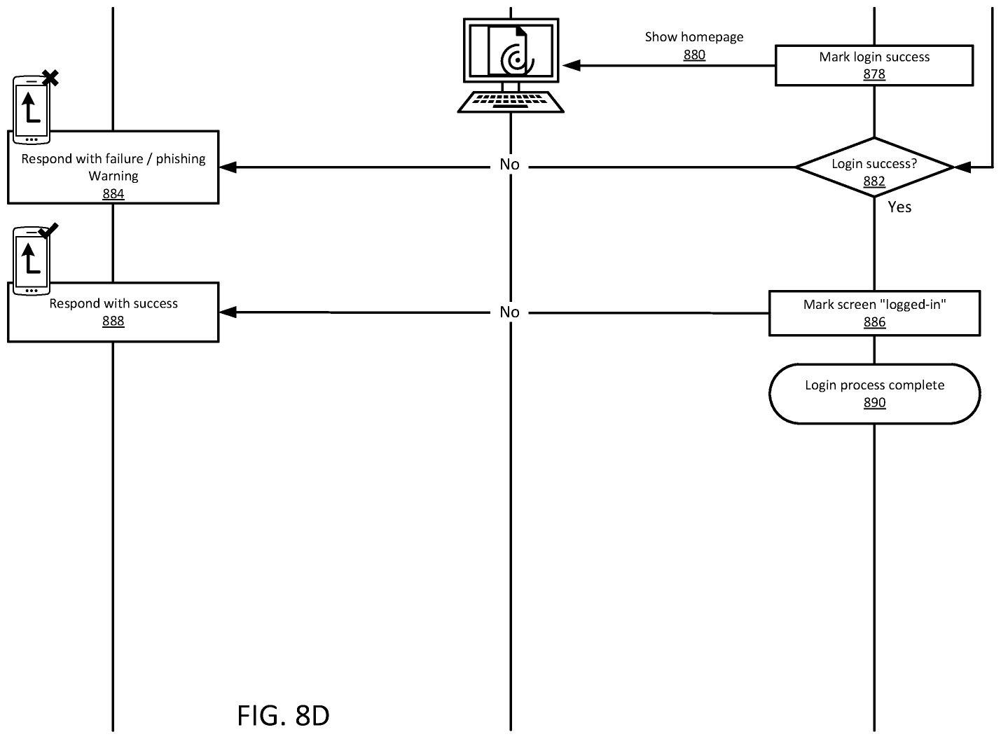

FIGS. 8A-8D illustrate another passwordless login process 800 executed by a passwordless login system (e.g., the system 300 of FIG. 3). As shown in FIGS. 8A-8D, the process 800 starts with a browser hosted by a client computer system (e.g., the client computer system 304 of FIG. 3) opening 802 a login page served to the browser by a login service (e.g., the login service 330 of FIG. 3). The login service may be hosted, for example, by a server (e.g., the server computer system 306 of FIG. 3). During load of the login page, the browser sends 804 a hypertext transfer protocol (HTTP) cookie to the login service. The login service receives the cookie and attempts to retrieve 806 a screen identifier therefrom. Where the login service does not find 808 a screen identifier within the cookie, the login service redirects 810 the browser to a client computer registration page.

The operations 802-864 of the process 800 are analogous to the operations 702-764 of the process 700. As such, a description of the operations 702-764, which are applicable to the operations 802-864, will not be repeated here. Rather the description of the process 800 starts with the login service determining 864 whether the user account associated with the username can be used with the client computer. For instance, in one example, the login service interoperates with a directory service to determine whether the user account associated with the username is authorized to use the client computer. If not, the login service responds 866 to the login agent with a message that indicates the login process 800 failed due to an access failure. Otherwise, the login service marks 867 the web session as “ready-to-login” and waits for a login status change. As part of the operation 867, the login service transmits a web page to the browser that reflects the web session status of “ready-to-login”. The web page includes an instruction to automatically refresh itself.

Continuing the process 800, the browser refreshes 868 the web page. As a further anti-phishing evaluation, the login service attempts 870 to confirm that the screen identifier contained within the cookie received as part of the refresh operation 868 matches the screen identifier contained within the cookie received in the operation 806. Where the login service does not confirm 872 that the screen identifiers contained within the cookies match, the login service stores an indication of login failure in the login data store and notifies 874 the browser of a login failure by, for example, transmitting a failure web page that indicates the same. Responsive to reception of the failure web page, the browser displays 876 the failure web page. With reference to FIG. 8D, where the login service confirms 872 that the screen identifiers contained within the cookies match, the login service stores an indication of login success 878 in the login data store and transmits 880 a logged in homepage to the browser. The browser displays the homepage responsive to reception.

Continuing the process 800, the login service determines 882 whether login was successful. For instance, in one example, the login service checks the login data store for an indication of success (e.g., as stored in the operation 878) or an indication of failure (e.g., as stored in the operation 874). Where the login service determines 882 that the login was not successful, the login service responds 884 to the login agent with a message indicating login failure and warning of phishing activity. Where the login service determines 882 that the login was successful, the login service marks 886 the web session as “logged-in” (e.g., via interoperation with a directory service), responds 888 to the login agent with a message that indicates the login process 800 succeeded, and stores 890 (e.g., in the login data store) an indication that the login process 800 is complete.

FIGS. 9A and 9B illustrate another registration process 900 executed by registration components of a passwordless login system (e.g., the system 300 of FIG. 3). As shown in FIGS. 9A and 9B, the process 900 starts with a browser hosted by a client computer system (e.g., the client computer system 304 of FIG. 3) opening 902 a registration page served to the browser by a registration service (e.g., the registration service 336 of FIG. 3). The registration service may be hosted, for example, by a server (e.g., the server computer system 306 of FIG. 3). The registration page prompts a user to enter security credentials (e.g., username and password). In response to receiving input specifying the user's security credentials, the browser transmits the same to the registration service.

Continuing with the process 900, the registration service authenticates the security credentials (e.g., by interoperating with an identity provider/directory service). Next, the registration service generates 904 a unique and temporary registration session identifier/token and stores an association between the username and the token in a registration data store (e.g. the registration data store 340 of FIG. 3). The registration service encodes 906 a link to an API endpoint implemented by the registration service and the token in a QR code and transmits the QR code to the browser within a web page.

Continuing with the process 900, the browser displays 908 the web page. The web page includes the QR code, a prompt that instructs the user to scan the QR code and to enter a security code (e.g., a 4-digit security code) once the code is presented to the user via a mobile device (e.g., the mobile computing device 302 of FIG. 3). The web page also includes a control configured to accept the code.

Continuing with the process 900, the mobile device scans 910 the QR code and launches a registration agent (e.g., the registration agent 316 of FIG. 3) associated with the QR code. The registration agent obtains 912 the link and the registration token from the QR code. The registration agent uses the cryptographic features of the mobile device to generate 914 a private/public key pair. The private key remains stored within cryptographic hardware of the mobile device (e.g., within the secure chip 322 and/or the secure data store 320 of FIG. 3). The public key is stored within keychain storage (e.g., within the agent data store 312). The registration agent transmits 916 a registration request to the link obtained in operation 912. The request includes data specifying the token, the public key, and an identifier of the mobile device.

Continuing with the process 900, the registration service validates 918 the token (e.g., by searching for it within the registration data store) and stores, within the registration data store, an association between the public key, the mobile device identifier, and the registration session (e.g., via the token). The registration service generates 920 the code and stores, within the registration data store, an association between the code and the registration session (e.g., via the token). The registration service responds 922 to the registration request with a message including the token and the code.

Continuing with the process 900, the registration agent receives the response and displays 924 the code and prompts the user to enter the code into the browser and then to tap “continue” on the mobile device. The browser receives input specifying the code and, with continued reference to FIG. 9b, transmits 926 a message to the registration service that includes data specifying the code.

Continuing with the process 900, the registration service receives the message and confirms 928 that the received code matches the code associated with the registration session. Next, the registration service serves a web page to the browser that prompts 930 the user to re-enter security credentials. The browser receives the web page and renders the web page. The browser receives input specifying the security credentials and transmits 932 the same to the registration service. The registration service authenticates the security credentials (e.g., by interoperating with an identity provider/directory service). The registration service stores 934 an indication that the code is valid and the security credentials are authentic in the registration data store. The registration service serves 936 a web page to the browser that prompts the user to tap “continue” on the mobile device.

Continuing with the process 900, the registration agent receives 938 input indicating that the user tapped “continue”. The registration agent utilizes the security chip of the mobile device to authenticate 940 (e.g., biometrically) the user and sign 942 the code with the private key generated in the operation 914. The registration agent transmits 944 another registration request to the registration service. The request includes data specifying the token, username, and signed code.

Continuing with the process 900, the registration service receives the registration request and validates 946 the token (e.g., by looking up the token within the registration data store). Next, the registration service verifies 948 the code using the public key associated with the device identifier and responds 950 to the registration request with a message that includes the token and the username.

Continuing with the process 900, the registration agent stores 952 an association between the key pair and the username and an association between the username and the link in the agent data store. Next, the registration agent transmits 954 a completion request to the registration service. The completion request includes the token.

Continuing with the process 900, the registration service receives the completion request and validates 956 the token (e.g., by looking up the token within the registration data store). Next the registration service stores 958 an association between the mobile device identifier and the username in the registration data store and marks the mobile device as ready to use for passwordless logins. The registration service responds 960 to the completion request with a message indicating that the registration process 900 is complete. The registration service stores 962, in the registration data store, an indication that the registration process is complete and the process 900 ends.

The processes as disclosed herein each depict one particular sequence of operations in a particular example. Some operations are optional and, as such, can be omitted in accord with one or more examples. Additionally, the order of operations can be altered, or other operations can be added, without departing from the scope of the apparatus and methods described herein.

Computing Device for Passwordless Login Systems

FIG. 10 is a block diagram of a computing device 1000 configured to implement various passwordless login systems and processes in accordance with examples disclosed herein.

The computing device 1000 includes one or more processor(s) 1003, volatile memory 1022 (e.g., random access memory (RAM)), non-volatile memory 1028, a user interface (UI) 1070, one or more network or communication interfaces 1018, and a communications bus 1050. The computing device 1000 may also be referred to as a client device, computing device, endpoint, computer, or a computer system.

The non-volatile (non-transitory) memory 1028 can include: one or more hard disk drives (HDDs) or other magnetic or optical storage media; one or more solid state drives (SSDs), such as a flash drive or other solid-state storage media; one or more hybrid magnetic and solid-state drives; or one or more virtual storage volumes, such as a cloud storage, or a combination of such physical storage volumes and virtual storage volumes or arrays thereof.

The user interface 1070 can include a graphical user interface (GUI) (e.g., controls presented on a touchscreen, a display, etc.) and one or more input/output (I/O) devices (e.g., a mouse, a keyboard, a microphone, one or more speakers, one or more cameras, one or more biometric scanners, one or more environmental sensors, and one or more accelerometers, one or more visors, etc.).

The non-volatile memory 1028 stores an OS 1015, one or more applications or programs 1016, and data 1017. The OS 1015 and the application 1016 include sequences of instructions that are encoded for execution by processor(s) 1003. Execution of these instructions results in manipulated data. Prior to their execution, the instructions can be copied to the volatile memory 1022. In some examples, the volatile memory 1022 can include one or more types of RAM or a cache memory that can offer a faster response time than a main memory. Data can be entered through the user interface 1070 or received from the other I/O device(s), such as the network interface 1018. The various elements of the device 1000 described above can communicate with one another via the communications bus 1050.

The illustrated computing device 1000 is shown merely as an example client device or server and can be implemented within any computing or processing environment with any type of physical or virtual machine or set of physical and virtual machines that can have suitable hardware or software capable of operating as described herein.

The processor(s) 1003 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values or using analog signals.

In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory.

The processor(s) 1003 can be analog, digital or mixed. In some examples, the processor(s) 1003 can be one or more local physical processors or one or more remote-located physical processors. A processor including multiple processor cores or multiple processors can provide functionality for parallel, simultaneous execution of instructions or for parallel, simultaneous execution of one instruction on more than one piece of data.

The network interfaces 1018 can include one or more interfaces to enable the computing device 1000 to access a computer network 1080 such as a Local Area Network (LAN), a Wide Area Network (WAN), a Personal Area Network (PAN), or the Internet through a variety of wired or wireless connections, including cellular connections and Bluetooth connections. In some examples, the network 1080 may allow for communication with other computing devices 1090, to enable distributed computing.

In described examples, the computing device 1000 can execute an application on behalf of a user of a client device. For example, the computing device 1000 can execute one or more virtual machines managed by a hypervisor. Each virtual machine can provide an execution session within which applications execute on behalf of a user or a client device, such as a hosted desktop session. The computing device 1000 can also execute a terminal services session to provide a hosted desktop environment. The computing device 1000 can provide access to a host computing environment including one or more applications, one or more desktop applications, and one or more desktop sessions in which one or more applications can execute.

Having thus described several aspects of at least one example, it is to be appreciated that various alterations, modifications, and improvements will readily occur to those skilled in the art. For instance, examples disclosed herein can also be used in other contexts. Such alterations, modifications, and improvements are intended to be part of this disclosure and are intended to be within the scope of the examples discussed herein. Accordingly, the foregoing description and drawings are by way of example only.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

Additional Examples

Descriptions of additional examples follow. Other variations will be apparent in light of this disclosure.

Example 1 is a computer system comprising a memory; a network interface; and at least one processor coupled to the memory and the network interface and configured to receive, via the network interface, a signed response to a challenge, verify the signed response using a public key associated with a mobile computing device, and log a user account associated with the public key into an application in response to verification of the signed response, thereby allowing access to the application.

Example 2 includes the subject matter of Example 1, wherein the at least one processor is further configured to identify an association between the application and a client computer system hosting the application.

Example 3 includes the subject matter of Example 1 or Example 2, wherein the application comprises either a browser or an operating system.

Example 4 include the subject matter of Example 3, wherein the application is a digital workspace client.

Example 5 includes the subject matter of any of Examples 1 through 4, further comprising the mobile computing device, wherein the mobile computing device comprises a security chip and is configured to receive the challenge; sign the challenge with a private key using the security chip to generate the signed response; and transmit the signed response to the at least one processor.

Example 6 includes the subject matter of Example 5, wherein the mobile computing device further comprises at least one biometric sensor and is further configured to biometrically authenticate a user as an owner of the private key prior to signature of the challenge.

Example 7 includes the subject matter of any of Examples 1 through 6, wherein the at least one processor is further configured to transmit, to the application via the network interface, an identifier of an application programming interface (API) endpoint implemented by the at least one processor, and to receive the signed response comprises to receive the signed response via the API endpoint.

Example 8 includes the subject matter of Example 7, further comprising a client computer configured to execute the application; receive the identifier of the API endpoint; and communicate the identifier of the API endpoint to the mobile computing device.

Example 9 includes the subject matter of Example 8, wherein to communicate the identifier comprises either to render a QR code encoding the identifier of the API endpoint or to transmit a wave modulated to encode the identifier of the API endpoint.

Example 10 includes the subject matter of Example 8 or Example 9, further comprising the mobile computing device, the mobile computing device further comprising a camera, wherein to communicate the identifier comprises to render a QR code encoding the identifier of the API endpoint; and the mobile computing device is configured to scan the QR code with the camera to receive the identifier of the API endpoint, and transmit the signed response to the API endpoint.

Example 11 is a method of logging into a computer system without a password. The method comprises receiving a signed response to the challenge; verifying the signed response using a public key associated with the mobile computing device; and logging a user account associated with the public key into an application comprising a browser in response to verification of the signed response, thereby allowing access to the application.

Example 12 includes the subject matter of Example 11, wherein logging the user account into the application comprises logging the user account into a digital workspace client.

Example 13 includes the subject matter of Example 11 or Example 12, further comprising receiving, by the mobile computing device, the challenge; signing the challenge with a private key using a security chip to generate the signed response; and transmitting the signed response to at least one processor of the computer system.

Example 14 includes the subject matter of Example 13, further comprising biometrically authenticating a user as an owner of the private key prior to signature of the challenge.

Example 15 includes the subject matter of any of Examples 11 through 14, further comprising transmitting, to the application, an identifier of an application programming interface (API) endpoint, wherein receiving the signed response comprises receiving the signed response via the API endpoint.

Example 16 includes the subject matter of Example 15, further comprising hosting, by a client computer, the application; receiving the identifier of the API endpoint; and communicating the identifier of the API endpoint to the mobile computing device.

Example 17 includes the subject matter of Example 16, wherein communicating the identifier comprises either rendering a QR code encoding the identifier of the API endpoint or transmitting a wave modulated to encode the identifier of the API endpoint.

Example 18 includes the subject matter of Example 16 or Example 17, wherein communicating the identifier comprises rendering a QR code encoding the identifier of the API endpoint and the method further comprises scanning the QR code with a camera of the mobile computing device to receive the identifier of the API endpoint, and transmitting, by the mobile computing device, the signed response to the API endpoint.

Example 19 is a non-transitory computer readable medium storing processor executable instructions to log into a computer system without a password, the instructions comprising instructions to receive a signed response to a challenge; verify the signed response using a public key associated with a mobile computing device; and log a user account associated with the public key into an application comprising a browser in response to verification of the signed response, thereby allowing access to the application.

Example 20 includes the subject matter of Example 19, wherein the application comprises a digital workspace client.

Example 21 includes the subject matter of Example 19 or Example 20, the instructions further comprise instructions to transmit, to the application, an identifier of an application programming interface (API) endpoint, wherein to receive the signed response comprises to receive the signed response via the API endpoint.

Example 22 is a mobile computing device comprising a memory; a network interface; and at least one processor coupled to the memory, and the network interface and configured to transmit, via the network interface, a login request to a computer system, receive, via the network interface, a challenge in response to the login request, initiate signature of the challenge to generate a signed response, and transmit, via the network interface, the signed response to the computer system.

Example 23 includes the subject matter of Example 22, further comprising a secure local storage configured to store a private key; and a security chip configured to sign the challenge using the private key.

Example 24 includes the subject matter of Example 23, further comprising a sensor coupled to the at least one processor, wherein the at least one processor is further configured to authenticate an owner of the private key prior to initiation of the signature.

Example 25 includes the subject matter of Example 24, wherein the sensor comprises a biometric sensor.

1. A computer system comprising:
a memory;
a network interface; and
at least one processor coupled to the memory and the network interface and configured to
receive, via the network interface, a signed response to a challenge,
verify the signed response using a public key associated with a mobile computing device, and
log a user account associated with the public key into an application in response to verification of the signed response, thereby allowing access to the application.

2. The computer system of claim 1, wherein the at least one processor is further configured to identify an association between the application and a client computer system hosting the application.

3. The computer system of claim 1, wherein the application comprises either a browser or an operating system.

4. The computer system of claim 3, wherein the application is a digital workspace client.

5. The computer system of claim 1, further comprising the mobile computing device, wherein the mobile computing device comprises a security chip and is configured to:
receive the challenge;
sign the challenge with a private key using the security chip to generate the signed response; and
transmit the signed response to the at least one processor.

6. The computer system of claim 5, wherein the mobile computing device further comprises at least one biometric sensor and is further configured to biometrically authenticate a user prior to signature of the challenge.

7. The computer system of claim 1, wherein:
the at least one processor is further configured to transmit, to the application via the network interface, an identifier of an application programming interface (API) endpoint implemented by the at least one processor, and
to receive the signed response comprises to receive the signed response via the API endpoint.

8. The computer system of claim 7, further comprising a client computer configured to:
execute the application;
receive the identifier of the API endpoint; and
communicate the identifier of the API endpoint to the mobile computing device.

9. The computer system of claim 8, wherein to communicate the identifier comprises either to render a QR code encoding the identifier of the API endpoint or to transmit a wave modulated to encode the identifier of the API endpoint.

10. The computer system of claim 8, further comprising the mobile computing device, the mobile computing device further comprising a camera, wherein:
to communicate the identifier comprises to render a QR code encoding the identifier of the API endpoint; and
the mobile computing device is configured to
scan the QR code with the camera to receive the identifier of the API endpoint, and
transmit the signed response to the API endpoint.

11. A method of logging into a computer system without a password, the method comprising:
receiving a signed response to a challenge;
verifying the signed response using a public key associated with a mobile computing device; and
logging a user account associated with the public key into an application comprising a browser in response to verification of the signed response, thereby allowing access to the application.

12. The method of claim 11, wherein logging the user account into the application comprises logging the user account into a digital workspace client.

13. The method of claim 11, further comprising:
receiving, by the mobile computing device, the challenge;
signing the challenge with a private key using a security chip to generate the signed response; and
transmitting the signed response to at least one processor of the computer system.

14. The method of claim 13, further comprising biometrically authenticating a user prior to signature of the challenge.

15. The method of claim 11, further comprising transmitting, to the application, an identifier of an application programming interface (API) endpoint, wherein receiving the signed response comprises receiving the signed response via the API endpoint.

16. The method of claim 15, further comprising:
hosting, by a client computer, the application;
receiving the identifier of the API endpoint; and
communicating the identifier of the API endpoint to the mobile computing device.

17. The method of claim 16, wherein communicating the identifier comprises either rendering a QR code encoding the identifier of the API endpoint or transmitting a wave modulated to encode the identifier of the API endpoint.

18. The method of claim 16, wherein communicating the identifier comprises rendering a QR code encoding the identifier of the API endpoint and the method further comprises:
scanning the QR code with a camera of the mobile computing device to receive the identifier of the API endpoint, and
transmitting, by the mobile computing device, the signed response to the API endpoint.

19. A non-transitory computer readable medium storing processor executable instructions to log into a computer system without a password, the instructions comprising instructions to:
receive a signed response to a challenge;
verify the signed response using a public key associated with a mobile computing device; and
log a user account associated with the public key into an application comprising a browser in response to verification of the signed response, thereby allowing access to the application.

20. The non-transitory computer readable medium of claim 19, wherein the application comprises a digital workspace client.

21. The non-transitory computer readable medium of claim 19, wherein the instructions further comprise instructions to transmit, to the application, an identifier of an application programming interface (API) endpoint, wherein to receive the signed response comprises to receive the signed response via the API endpoint.

22. A mobile computing device comprising:
a memory;
a network interface; and
at least one processor coupled to the memory, and the network interface and configured to
transmit, via the network interface, a login request to a computer system,
receive, via the network interface, a challenge in response to the login request,
initiate signature of the challenge to generate a signed response, and
transmit, via the network interface, the signed response to the computer system.

23. The mobile computing device of claim 22, further comprising:
a secure local storage configured to store a private key; and
a security chip configured to sign the challenge using the private key.

24. The mobile computing device of claim 23, further comprising a sensor coupled to the at least one processor, wherein the at least one processor is further configured to authenticate an owner of the private key prior to initiation of the signature.

25. The mobile computing device of claim 24, wherein the sensor comprises a biometric sensor.
